(19) United States
(12) Patent Application Publication
(10) Pub. No.: US 2024/0242852 A1
(43) Pub. Date: Jul. 18, 2024

(54) SOLID TARGET IRRADIATOR SYSTEM FOR RADIOISOTOPES PRODUCTION

(71) Applicant: Best Theratronics Ltd., Ottawa, Ontario (CA)

(72) Inventor: William Zeev Gelbart, Vancouver, British Columbia (CA)

(21) Appl. No.: 18/560,132

(22) PCT Filed: May 12, 2022
(86) PCT No.: PCT/CA2022/050752

§ 371 Date: Nov. 10, 2023

Related U.S. Application Data
(60) Provisional application No. 63/187,898, filed on May 12, 2021.
(60) Provisional application No. 63/241,324, filed on Sep. 7, 2021.

(51) Int. Cl. G21G 1/00; G21G 1/04; G21K 5/10

(52) U.S. Cl. CPC G21G 1/0005; G21G 1/04; G21K 5/10; G21K 2201/065; G21K 2201/067

(57) ABSTRACT

A solid target irradiator system (10, 210) includes a target carrier feeding assembly (20, 220) coupled to a base (11, 211) for sequentially feeding individual target carriers (50, 250) from a stack of target carriers contained in a target magazine (21, 221), a target loader assembly (60, 260) coupled to the base for selectively holding each target carrier in the target magazine for subsequent advancement and retraction of a held target carrier through the solid target irradiator system, a selectively moveable dissolution assembly (100, 300) coupled to the base and selectively engageable with the target loader assembly for dissolution of target material thereon; and an airlock assembly (80, 280) coupled to the base to prepare the target carrier for subsequent irradiation.

### CROSS REFERENCE TO RELATED APPLICATION

This application claims priority under 35 U.S.C. § 119 to U.S. Provisional Patent Application Nos. 63/187,898, filed May 12, 2021, and 63/241,324, filed Sep. 7, 2021, which are incorporated herein by reference in its entirety.

### FIELD OF THE INVENTION

The invention generally relates to the field of radioisotope production, and more particularly to solid target systems allowing the remote manipulation and dissolution of solid targets used in positive ion cyclotrons.

### BACKGROUND ART

Radioisotopes are isotopes of a chemical element. They have an excess of energy, which they release in the form of radiation. They can occur naturally or be produced artificially, mainly in research reactors and accelerators. Radioisotopes are used in various fields, including nuclear medicine, industry, agriculture and research.

In the early days of radioisotope production using cyclotrons and still in use today in some facilities, a circulating beam of positive ions (usually protons) were directed onto a radioisotope production target mounted in the inside of the cyclotron vacuum chamber. This required numerous vacuum, cooling water, and electrical signal connections to the production target to allow the target to operate inside the cyclotron. Since radioisotope production target need cooling (usually water) to remove the heat generated by the beam, a coolant connection must be made inside the cyclotron vacuum chamber. This can lead to loss of vacuum in the case of a small coolant leak, or even the catastrophic flooding of the cyclotron vacuum chamber in the event of the connection failure.

Progressing from the internal targets, target location was replaced by an external position when negative ion (usually H⁻) acceleration and high efficiency electron stripping lead to positive ion (usually H⁺) development of external beams. This allows to place the target and the coolant connections outside the cyclotron vacuum tank. However, the negative ion source produces less ion intensity than a positive ion source and the extraction system though efficient requires regular maintenance and the actual radioisotope production target occupies an expanded space footprint.

The cladding of the target substrate can be performed in a number of ways such as including to electrodeposition, sputtering, laser cladding, diffusion bonding and foil soldering, but not limited thereto.

There has been development of small cyclotrons for radioisotope production in a hospital setting where positive ions are accelerated to bombard water targets at energies less than 10 MeV to produce F-18 for PET diagnostic scans. Positive ion acceleration and targets internal to the cyclotron vacuum system are used to reduce the footprint and complexity of the system to meet the hospital needs for a small radioisotope production system. Such systems are presently limited to the production of F-18 because of the immediate capability to the irradiated water to be transferred to the drug synthesis unit.

The irradiating particle beam typically generates high heat in the target material that even with cooling results in a temperature that exceeds the melting point of the target material can be reached. This will cause the melting of the target material and subsequent loss from the substrate.

For example, Siikanen et al., (Applied Radiation and Isotopes, Volume 94, December 2014, Pages 294-301) disclose a solid target system with remote handing of irradiated targets for PET cyclotron. They demonstrate a simple and affordable pneumatically maneuverable solid target system that uses manual insertion of targets which are then held by vacuum and positioned pneumatically to and from irradiation position and dropped by gravity in a lead shield after irradiation. The system is flexible and handles all target materials in the form of foils, electroplated/sputtered plates or metals pressed into an indentation within a backing metal thus making it possible to produce a broad spectrum of different radionuclides like 86Y, 66, 68Ga, 60, 61, 64Cu, 45Ti and many more radionuclides.

While there have been some attempts to produce targets apparatus for nuclear medicine, such attempts have not adequately addressed an efficient method and system to overcome the aforementioned drawbacks. Thus, an efficient target system allowing the remote manipulation and dissolution of solid targets used in positive ion cyclotrons for producing radioisotopes addressing the aforementioned needs is desired.

### SUMMARY OF INVENTION

The solid target irradiator system includes a target carrier feeding assembly coupled to the base for sequentially feeding individual target carriers from a stack of target carriers contained in a target magazine, a target loader assembly coupled to the base for selectively holding each target carrier in the target magazine for subsequent advancement and retraction of a held target carrier through the solid target irradiator system, a selectively moveable dissolution assembly coupled to the base and selectively engageable with the target loader assembly for dissolution of target material thereon, and an airlock assembly coupled to the base to prepare the target carrier for subsequent irradiation.

These and other features of the present invention will become readily apparent upon further review of the following specification and drawings.

### DESCRIPTION OF THE DRAWINGS

FIG. 1 is an environmental perspective view of a solid target irradiator system for radioisotopes production according to the present invention.

FIG. 2 is an exploded view of a target loader assembly in the solid target irradiator system of FIG. 1 according to the present invention.

FIG. 3 is an exploded view of a target carrier cassette/magazine in the solid target irradiator system of FIG. 1 according to the present invention.

FIG. 4 is a perspective view of one support member for the target carrier magazine in the solid target irradiator system of FIG. 1 according to the present invention.

FIG. 5 is a rear perspective view of a target carrier carrying deposited target material for the solid target irradiator system of FIG. 1 according to the present invention.

FIG. 6 is a sectional view of a coupling between a target manipulator tube and the target carrier for subsequent manipulation of the target carrier through an irradiation process in the solid target irradiator system of FIG. 1 according to the present invention.

FIG. 7 is a perspective view of a dissolution assembly in the solid target irradiator system of FIG. 1 according to the present invention.

FIG. 8 is a rear perspective, partial sectional view of an airlock assembly in the solid target irradiator system of FIG. 1 according to the present invention.

FIG. 9 is a perspective view of a sealing clamp for the airlock assembly of FIG. 8 according to the present invention.

FIG. 10 is a perspective view of the solid target irradiator system of FIG. 1 in a ready state for target carrier acquisition according to the present invention.

FIG. 11 is a perspective view of the solid target irradiator system of FIG. 1 in a target acquisition state where a tip portion of the target manipulator tube is coupled to a target carrier in a target carrier magazine according to the present invention.

FIG. 12 is a perspective view of the solid target irradiator system of FIG. 1 in a path-clearing state for subsequent feeding of the acquired target carrier towards the airlock assembly according to the present invention.

FIG. 13 is a perspective view of the solid target irradiator system of FIG. 1 in an atmosphere conditioning state where the acquired target carrier is fed into the airlock assembly and vacuum sealed according to the present invention.

FIG. 14 is a perspective view of the solid target irradiator system of FIG. 1 in a target material irradiation state where the target material on the target carrier is exposed outside the airlock assembly and positioned to intersect radiation beams from a cyclotron according to the present invention.

FIG. 15 is a perspective view of the solid target irradiator system of FIG. 1 in a post target material irradiation end state where the target carrier is retracted back into the airlock assembly according to the present invention.

FIG. 16 is a perspective view of the solid target irradiator system of FIG. 1 in a dissolution process state where the target carrier is sealed against the dissolution assembly and subjected to a dissolution process according to the present invention.

FIG. 17 is a perspective view of the solid target irradiator system of FIG. 1 in a post dissolution process end state where the spent target carrier is stripped off the tip portion of the loader arm and disposed according to the present invention.

FIG. 18 is an environmental perspective view of an alternative solid target irradiator system according to the present invention.

FIG. 19 is a partial sectional view of the solid target irradiator system of FIG. 18 according to the present invention.

FIG. 20 is a partial sectional view of an alternative target carrier cassette/magazine for the solid target irradiator system of FIG. 18 according to the present invention, the target carrier magazine being shown with a full load of target carriers.

FIG. 21 is a partial sectional view of the target magazine shown in FIG. 20 according to the present invention, the target carrier magazine being shown in an empty state.

FIG. 22 is a perspective view of a front panel for the target carrier magazine shown in FIGS. 18, 20, and 21 according to the present invention.

FIG. 23 is a rear perspective view of an alternative target carrier carrying deposited target material for the solid target irradiator system of FIG. 18 according to the present invention.

FIG. 24 is a sectional view of a tip portion of a loader arm for the solid target irradiator system of FIG. 18 according to the present invention.

FIG. 24A is a perspective view of an alternative nozzle head on an inner tube of the loader arm for the irradiator system of FIG. 18 according to the present invention.

FIG. 24B is a sectional view of a loader arm and the alternative nozzle head in FIG. 24A for the irradiator system of FIG. 18 according to the present invention.

FIG. 25 is a sectional view of a coupling between a target plug of the loader arm and the target carrier for subsequent manipulation of the target carrier through an irradiation process in the solid target irradiator system of FIG. 18 according to the present invention.

FIG. 26 is side perspective view of the solid target irradiator system of FIG. 18 according to the present invention, this view detailing a process of ejecting a spent target carrier.

FIG. 27 is a top perspective view of the solid target irradiator system as shown in FIG. 26 according to the present invention, this view providing more details of features between a spent target carrier to be ejected and an airlock assembly.

FIG. 28 is a sectional view of an airlock assembly in the solid target irradiator system of FIG. 18 according to the present invention with a gate valve in a closed state.

FIG. 29 is a perspective view of an alternative dissolution assembly in the solid target irradiator system of FIG. 18 according to the present invention.

FIG. 30 is a sectional view of the dissolution assembly shown in FIG. 29 in a dissolution processing state according to the present invention.

FIG. 31 is a block diagram for controlling various functions of the solid target irradiator system according to the present invention.

FIG. 32 is a schematic block diagram of a dissolution system for use with a solid target irradiator system according to the present invention.

FIG. 33 is an operational flow diagram for the solid target irradiator system according to the present invention.

Unless otherwise indicated, similar reference characters denote corresponding features consistently throughout the attached drawings.

### DETAILED DESCRIPTION

The solid target irradiator system for radioisotopes production, generally referred by reference number 10 in the drawings, provides a compact, automated, and safe production system for irradiation processing of a plurality of target materials 53 on respective target carriers 50 with minimal user interaction. The solid target irradiator system 10 includes a base 11; a target carrier feeding assembly 20 coupled to the base 11 for sequentially feeding individual target carriers 50 of the plurality of target carriers 50; a target loader assembly 60 coupled to the base 11 for selectively engaging each target carrier 50 for subsequent advancement and retraction of an engaged target carrier 50 through the solid target irradiator system 10; a selectively moveable dissolution assembly 100 coupled to the base 11 and downstream from the target loader assembly 60 for selective engagement with the target carrier 50 and dissolution of target material 53 thereon; and an airlock assembly 80 coupled to the base 11 to prepare the target carrier 50 for subsequent irradiation.

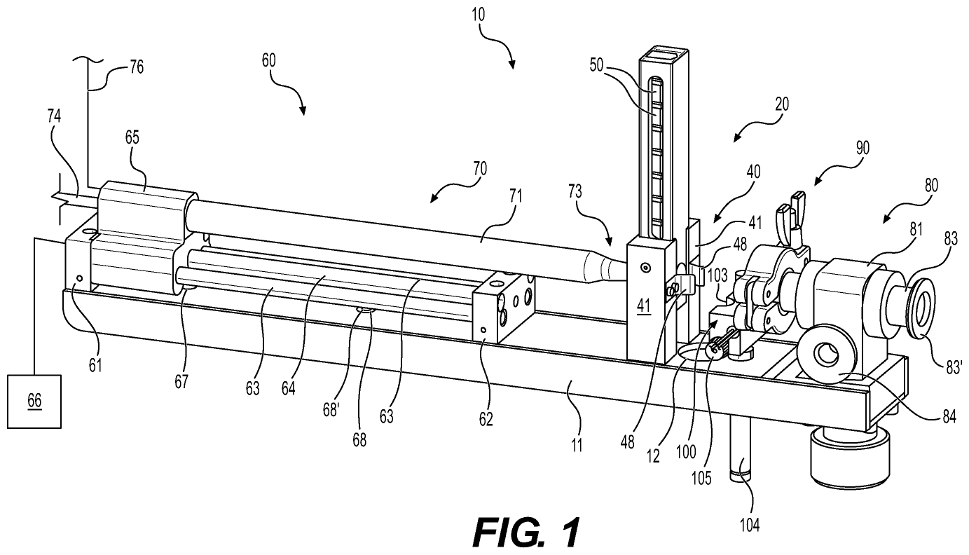

As shown in FIGS. 1 and 10-17, the base 11 is desirably an elongate, rectangular platform, beam, or member supporting various processing assemblies thereon. The target loader assembly 60 is mounted on one end of the base 11 and the airlock assembly 80 is mounted to the other end of the base 11. The target carrier feeding assembly 20 is mounted on the base 11 between the target loader assembly 60 and the airlock assembly 80 to enable the target loader assembly 60 load a select target carrier 50 to the airlock assembly 80. The dissolution assembly 100 is operatively mounted to the base 11 between the target carrier feeding assembly 20 and the airlock assembly 80. The order of these assemblies on the base 11 enables efficient processing of the target material for irradiation, dissolution thereof, and collection of radioisotopes from the dissolution process with minimal user or manual interaction, which substantially reduces potential instances of undesirable radiation exposure and other complications, thereby increasing general safety for the user.

To facilitate relatively swift processing of a set of a plurality of targets, the solid target irradiator system 10 is provided with the target carrier feeding assembly 20. As best seen in FIGS. 1-4, the target carrier feeding assembly 20 includes a selectively removable target cassette or magazine 21 slidably mounted to a target magazine support subassembly 40.

The target magazine 21 is desirably an elongate, rectangular tube member with a front panel 22, a back panel 23 spaced from the front panel 22, and a target holder bracket or cradle 28 sandwiched between the front and back panels 22, 23. When assembled, the target holder cradle 28 holds a stack or plurality of target carriers 50 within a U-shaped, open channel 32 in the target holder cradle 28. The front and back panels 22, 23 close opposing sides of the open channel 32 to form an elongate recess or receptacle for receiving/loading the stack of target carriers 50 therein.

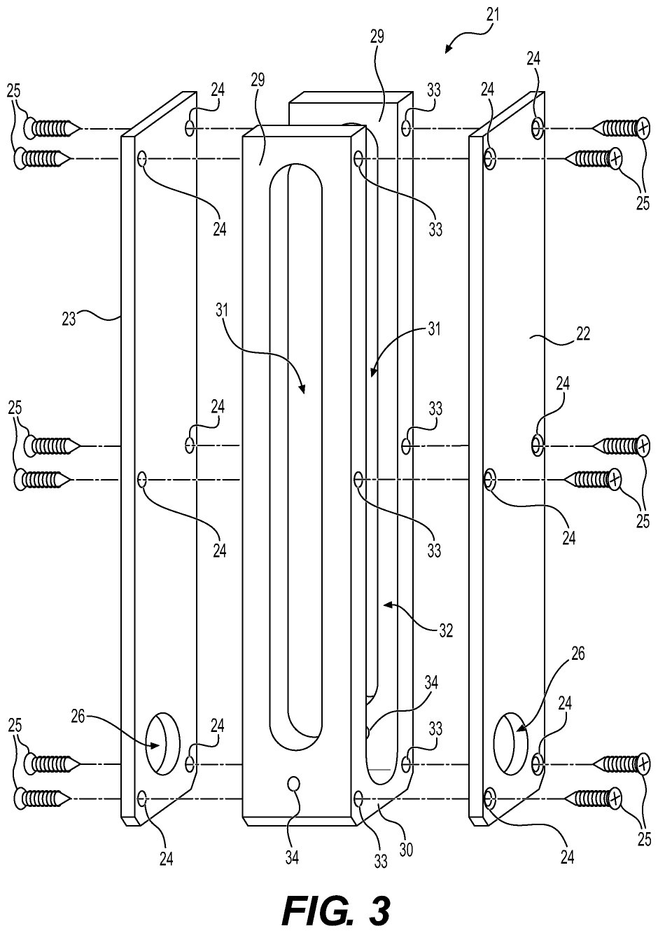

In an embodiment, both front and back panels 22, 23 are desirably identical elongate, rectangular plates, and the following features apply to both panels 22, 23. As best seen in FIG. 3, each panel 22, 23 includes a plurality of mounting holes 24 spaced along and near the long sides (e.g., left and right of each panel 22, 23 as shown in FIG. 3) of the respective panel. In an embodiment, each front and back panels 22, 23 is provided with a column of three mounting holes 24 near the left portion or one side of the panel 22, 23 and a column of three mounting holes 24 near the right portion or opposite side of the panel 22, 23. Though the number of mounting holes has been described as being three, it is to be understood that any number of mounting holes may be formed and utilized depending on application and use and should not be construed in a limiting sense. A desirably circular, pass-through hole 26 is formed near the bottom portion of each front and back panel 22, 23. These pass-through holes 26, 26 facilitate passage of components of the target loader assembly 60 and a select target carrier 50 from the target magazine 21 towards other assemblies of the solid target irradiator system 10 during use. As such, the pass-through holes 26, 26 are axially aligned and in operative communication with each other when assembled.

The target holder cradle 28 is desirably a U-shaped unitary member with a pair of spaced elongate leg sections 29, 29 interconnected by a lower bridge section 30. The leg sections 29, 29 and the bridge section 30 form the elongate open channel 32 in the space between leg sections 29, 29 and the bridge section 30. The bridge section 30 desirably includes an upper curved surface that conforms to an outer surface of the target carrier 50. This curved surface of the bridge section 30, however, can be configured to have any shape that substantially conforms to the target carrier 50 or otherwise holds the target carrier 50 in a relatively secure manner thereon. Each leg section 29, 29 has front and back edges (front and back being defined in the same spatial reference as with the panels 22, 23 above) provided with a plurality of panel mount holes 33. The number and locations of the panel mount holes 33 desirably match the number and locations of the mounting holes 24 on the front and back panels 22, 23, so that when assembled, the mounting holes 24 and the panel mount holes 33 align. The front panel 22 and the back panel 23 are secured to the front edges and the back edges, respectively, of the leg sections 29, 29 with fasteners 25, such as screws, bolts, and the like.

Each leg section 29, 29 is desirably provided with an elongate slot 31 formed thereon. These slots 31 serve as a window for viewing the number of target carriers 50 contained within the target magazine 21 for a user to determine when a refill of target carriers 50 is required, to visually inspect the target carriers 50, and/or to access target carriers 50 during loading of the target magazine 21. These slots 31 also reduce the overall weight of the target holder cradle 28.

Though the target magazine 21 has been described as being comprised of several parts, these parts can be combined into an integral target magazine 21 where some or all of the parts, such as the front panel 22, back panel 23, the target holder cradle 28, and/or sections thereof, are not separate structural elements. Such an integral target magazine 21 can be constructed via casting, molding, machining, 3D printing, and the like depending on the materials for the construction.

To secure the target magazine 21 onto the base 11, the target carrier feeding assembly 20 includes the target magazine support subassembly 40. As best seen in FIGS. 1, 2, and 4, the target magazine support subassembly 40 includes a pair of elongate, spaced support members 41, 41. Each support member 41 is desirably an elongate, rectangular block or body with a setscrew hole 42 extending through the thickness (left to right and vice versa in, e.g., FIGS. 1, 2, and 4) of the support member 41 near the top portion thereof. The setscrew hole 42 can be partially threaded. A pair of spaced mount holes 45, 45 are formed on the bottom of each support member 41 to enable selective mounting of the support members 41, 41 onto the base 11 with fasteners (not shown) in a vertical orientation orthogonal to the base 11.

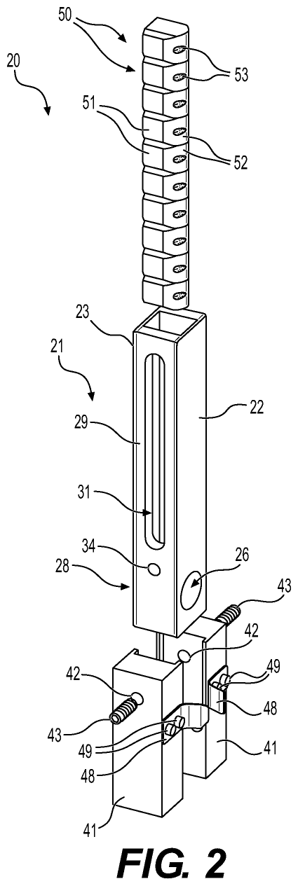

Each support member 41 is configured with an elongate magazine mount groove 44 extending a substantial length on one side of the support member 41 from the top thereof towards the bottom. This configuration of the magazine mount groove 44 includes an open end at top end of the magazine mount groove 44 and a generally closed end at bottom end of the magazine mount groove 44. When assembled, the support members 41, 41 are mounted to the base 11 so that the respective magazine mount grooves 44, 44 are disposed in spaced, opposite facing or mirrored relation to each other as best seen in FIG. 2. Each magazine mount groove 44 is generally rectangular in shape and dimensioned to accommodate a side width of the target magazine 21, such as the total side width of the front panel 22, target holder cradle 28, and the back panel 23 of the assembled target magazine 21. Additionally, the mounted spacing between the support members 41, 41 is configured to accommodate the width of the target magazine 21, such as the width of the front panel 22. Thus, during use, the spacing between the support members 41, 41; the width of the respective magazine mount grooves 44, 44; and the dimensional accommodations of the target magazine 21 afforded by these components enable relatively quick, easy, and selective insertion/mounting and retraction/removal of the target magazine 21 between the pair of support members 41, 41.

The closed end of the magazine mount groove 44 on each support member 41 includes an abutment ledge or magazine stop 46 that limits insertion of the target magazine 21 to a predefined depth. At this predefined depth, the target magazine 21 is fully seated between the support members 41, 41 with edge portions of the bottom of the target magazine 21 resting on the magazine stops 46, 46. This seated position of the target magazine 21 aligns each setscrew hole 42 of a respective support member 41 to a corresponding locking recess 34 on each leg section 29 of the target holder cradle 28. A locking member 43 for each support member 41 is threaded through the setscrew hole 42 to engage the locking recess 34 to fix the inserted target magazine 21 in place. This secures the mounting of the target magazine 21 to the support members 41, 41 and prevents undesirable movements of the target magazine 21 during use. The locking member 43 is desirably a spring plunger with a spring-loaded ball selectively seating inside the locking recess 34 during the process of seating the target magazine 21 between the support members 41, 41 to thereby lock the target magazine 21 in place. The spring plungers also enables easy and quick removal of the target magazine, for example to reload, by forced disengagement of the ball from the locking recess 34 during the act of lifting the target magazine 21 from the support members 41, 41. An example of a spring plunger is MacMAster 5901A132 High-Torque Ball-Nose Spring Plunger. It is noted that other types of spring plungers or quick-release type locking members can be used depending on application and use and should not be construed in a limiting sense.

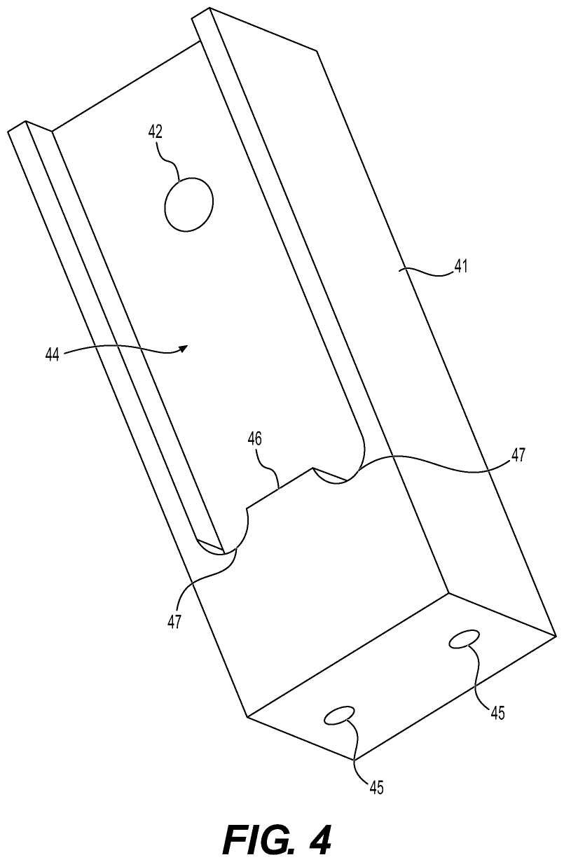

In an embodiment, each magazine mount groove 44 can be provided with groove extensions 47 at the bottom corners to provide clearance for access to the bottom of the target magazine 21. This access can assist the user in removing the target magazine 21 from the support members 41, especially in instances where the passage of the target magazine 21 may be hindered in some manner, without dismantling the target magazine support subassembly 40. The groove extension 47 can be semicircular as shown in FIG. 4 or any other shape that provides clearance and access.

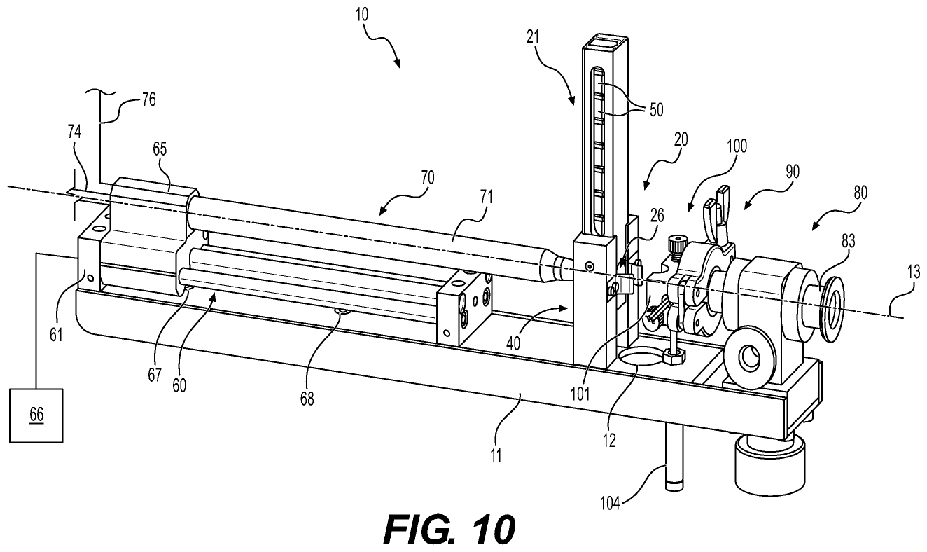

As best see in FIGS. 1, 2, and 10-17, each support member 41 includes a target stripper 48 detachably mounted to one side or front side of the corresponding support member 41 with fasteners 49. Each target stripper 48 is desirably an angled leaf spring with one relatively flat section mounted to the corresponding support member 41 and an angled section extending towards a common target processing axis 13, as best seen in FIG. 10, from the flat section. This common target processing axis 13 is defined by the coaxial alignment of the pass-through holes 26 and components of the target loader assembly 60 and the airlock assembly 80, the details of which will be further discussed below. When assembled, the angled sections of the target strippers 48, 48 are mirrored in that they extend towards each other at the same height on the respective support member 41 and towards the common target processing axis 13.

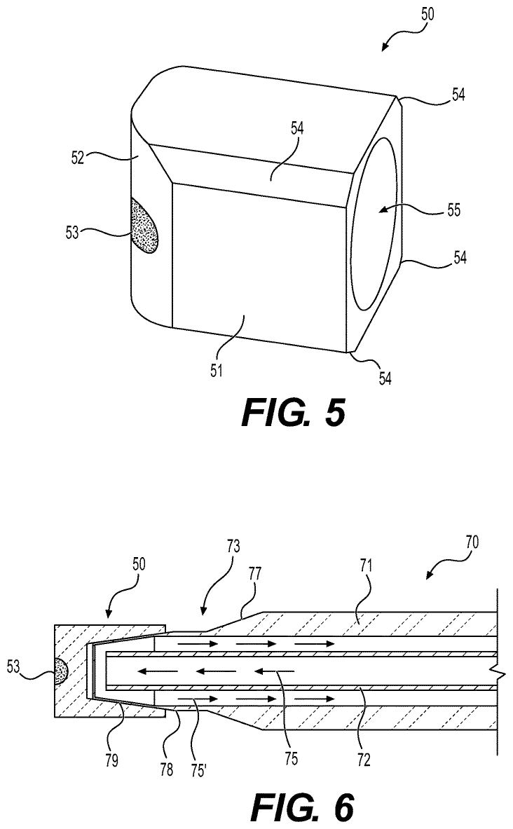

As best seen in FIGS. 1, 2, 5, 6, and 10-17, the target carrier 50 includes a generally rectangular block target body 51 with a curved front end or face 52. The target body 51 serves as a substrate for deposition of target material 53, the target material 53 being the material to be irradiated and processed to obtain radioisotopes. Some examples of materials for the target body 51 include copper, silver, or any other thermoconductive material, and examples of target material 53 include zinc, nickel, and other materials that can be irradiated and undergo a dissolution process for radioisotope production. In an embodiment, the target material 53 is deposited onto the curved front face 52 of the target body 51 so that the tip of the target carrier 50 with the target material 53 thereon will be presented and subjected to irradiation during operation of the solid target irradiator system 10. The front face 52 can include a shaped recess for the target material 53 or a relatively thin layer of target material 53 can be deposited onto the front face 52.

The rear end of the target carrier 50 is provided with a generally frustoconical shaped mount recess or socket 55 for selective coupling with the target loader assembly 60, the connection and interaction thereof will be further discussed below. Additionally, it is desirable to chamfer or bevel the corners of the target body 51 to form beveled edges 54. This removes potentially sharp corners for ease of handling during the process of loading/stacking the plurality of target carriers 50 into the target magazine 21. In a stacked configuration of target carriers 50, the beveled edges 54 between adjacent target carriers 50 form a V-shaped gap that enables easier access to individual or discrete target carriers 50 for stacking or removal. Additionally, the flat surfaces of the target body 51, especially the top and bottom, allow the user to easily stack and orient each target carrier 50 into the target magazine 21 so that each front face 52 is facing the same direction at the same orientation. This uniform orientation of the front faces 52 is greatly desired for processing the target carriers 50, since that will enable interception of radiation beams at the same predefined orientation for each target carrier 50, which results in a more efficient processing of the target carriers 50.

While the target carrier feeding assembly 20 facilitates storage and feeding of a plurality or stack of target carriers 50, the target loader assembly 60 loads a discrete target carrier 50 from the stack in the target magazine 21 towards and through other assemblies for irradiation and dissolution. As best seen in FIGS. 1, 6, and 10-17, the target loader assembly 60 includes a pair of spaced guide support brackets or a first guide support bracket 61 disposed on one end or rear end of the base 11 and a second guide support bracket 62 spaced from the first guide support bracket 61 downstream towards the opposite end or front end of the base 11. The first guide support bracket 61 and the second guide support bracket 62 are also referred to as guide support brackets 61, 62 for brevity. A pair of elongate, spaced guide rails or rods 63, 63 and an elongate drive shaft or rod 64 are coupled to and extend between the guide support brackets 61, 62. A manipulator carriage 65 is coupled to the guide rods 63, 63 and the drive rod 64 and configured to move or travel between the guide support brackets 61, 62 in a selective, reciprocal manner. The guide rods 63, 63 define a path of travel for the manipulator carriage 65, and the coupling between the manipulator carriage 65 and the guide rods 63, 63 permits the manipulator carriage 65 to slide along the guide rods 63, 63. The drive rod 64 is desirably coupled to a driver 66, such as a servomotor, linear actuator, pneumatic actuator, and the like. Selective activation of the driver 66 facilitates corresponding selective reciprocal movements of the manipulator carriage 65 via its connection with the drive rod 64.

In other embodiments, one or more of the guide rods 63 can function as a drive rod while the drive rod 64 can function as a guide rod. These embodiments can have the one or more drive rods connected to a common driver or multiple drivers. In other words, the arrangement of the guide rods 63, 63 and the drive rod 64 as shown in the drawings can be varied depending on application and use and should not be construed in any limiting sense.

The target loader assembly 60 also includes a plurality of carriage stops to halt the manipulator carriage 65 at predefined points along the path of travel. These predefined points relate to processing positions of the target loader assembly 60 during use which will be further described below. In an embodiment, the target loader assembly 60 includes a first carriage stop 67 and a second carriage stop 68 spaced along the length of the base 11 between the first guide support bracket 61 and the second guide support bracket 62. Each first and second carriage stops 67, 68 are desirably selectively actuatable pneumatic cylinders that upon actuation, raises a piston rod 68′ to a desired height. The piston rod 68′ serves as a stop abutment preventing further movement of the manipulator carriage 65 when the manipulator carriage 65 encounters the raised piston rod 68′. Selective retraction of the piston rod 68′ frees the manipulator carriage 65 for subsequent movement. The carriage stops can also be configured from mechanical, electrical, or electromechanical actuators depending on application and use and should not be construed in a limiting sense.

An elongate manipulator or loader arm 70 is mounted to the manipulator carriage 65 to be carried thereby. The loader arm 70 extends from the manipulator carriage 65 towards the target carrier feeding assembly 20 and terminates at a distal, free-standing tip section or target plug end 73. The loader arm 70 extends along the common target processing axis 13, so that it is coaxial and aligns with the pass-through holes 26 of the target magazine 21.

As best seen in FIG. 6, the loader arm 70 includes an elongate, circular outer tube 71 and an elongate, concentric and circular, inner tube 72. In an embodiment, the outer tube 71 terminates to a closed distal end, and the inner tube 72 terminates to an open distal end. A coolant supply line 74 is coupled to a rear end of the inner tube 72. The coolant supply line 74 selectively supplies coolant, for example fluid such as water or gas, through the inner tube 72 from the rear or back thereof to flow and exit out of the open end of the inner tube 72. The exiting coolant circulates within the space between the inner tube 72 and the outer tube 71 (indicated by coolant inflow arrows 75 and coolant outflow arrows 75′ in FIG. 6) to thereby cool an engaged target carrier 50 through thermal conduction between the engaged target carrier 50 and the closed distal end of the outer tube 71. The circulating coolant exits the outer tube 71 through a coolant outflow line 76 coupled to the rear of the outer tube 71.

The target plug end 73 is configured to selectively engage a target carrier 50 at the bottom of the target magazine 21. To facilitate this engagement or coupling, the target plug end 73 desirably includes multiple sections that form a substantially stepped frustoconical shape where each frustoconical section has smaller dimensions than the previous frustoconical section the closer that section is towards the distal end of the outer tube 71. For example, the target plug end 73 is configured with a first frustoconical section 77 with given first dimensions, e.g., taper angle, diameter, wall thickness, etc., terminating at an open end. One end of an intermediate section 78 is contiguous with the open end of the first frustoconical section 77, and the intermediate section 78 desirably has the same inner diameter as the outer tube 71 and the first frustoconical section 77. A second frustoconical section 79 extends from the opposite end of the intermediate section 78 and terminates to a closed end at the tip.

The second frustoconical section 79 is the portion of the target plug end 73 that selectively couples to the socket 55 of a select target carrier 50 in a socket-and-plug manner. Hence, it is desirable for both the target plug end 73 and the socket 55 to be configured with matching/mating geometries, e.g., frustoconical shape. Additionally, the taper angle of the second frustoconical section 79 is desirably 15° (degrees) to 10° inclusive angle as viewed in FIG. 6. This taper angle prevents slippage between the socket 55 and the second frustoconical section 79 and ensures that a relatively secure connection is maintained. Larger taper angles have a general tendency to let the target carrier 50 fall off the target plug end 73 during use, and lower taper angles could result in difficult to release of the holding connection.

Unlike the first frustoconical section 77, the second frustoconical section 79 is configured with the taper portion thereof having a relatively thin wall in the order of about 0.05 mm to 0.2 mm, more preferably about 0.1 mm. This thin wall provides a degree of flexibility to the second frustoconical section 79 such that fluid pressure from the incoming coolant through the inner tube 72 expands the thin wall to a degree for increased and pressurized fit inside the socket 55. The selective expansion of the thin wall facilitates a firm and secure hold on the engaged or coupled target carrier 50 so that the target carrier 50 will not unintentionally fall off while the target carrier 50 travels back and forth through the other assemblies on the solid target irradiator system 10 via the target loader assembly 60. The open end of the inner tube 72 is desirably disposed relatively close to the closed end of the second frustoconical section 79 to form a relatively small gap therebetween. This small gap assists in maximizing fluid pressure acting on the thin wall for subsequent expansion of the same and increases fluid velocity in the small gap thus increasing the heat transfer convection coefficient.

As can be seen from the above, the particulars of the loader arm 70 and the target carrier 50 provides an integrated, internal cooling of the target carrier 50 during irradiation. Most conventional target irradiators contend with the risk of catastrophic flooding (e.g., internal irradiator systems) or relatively large space footprint for components required in cooling and irradiating targets (e.g., external irradiator systems). These considerations are substantially reduced by the compact nature of the solid target irradiator system 10 and the integrated internal cooling in the loader arm 70.

Selective actuation of the target loader assembly 60 connects and holds the target plug end 73 of loader arm 70 with the bottommost target carrier 50. Further movement of the manipulator carriage 65 pushes the held target carrier 50 towards the airlock assembly 80 at the front end of the base 11. As best seen in FIGS. 1 and 8-17, the airlock assembly 80 includes a selectively actuatable gate valve 81 fixedly mounted to the front end of the base 11, a target entrance port 82 extending rearward from the rear of the gate valve 81, a target exit port 83 extending frontward from the front of the gate valve 81, and an atmosphere control port 84 extending from a side of the gate valve 81. Each target entrance port 82 and target exit port 83 is desirably a flanged cylinder provided with a respective annular flange 82′, 83′ at an end for selective coupling to other components. For example, the flange 83′ on the target exit port 83 enables coupling of the gate valve 81 (and thereby the solid target irradiator system 10) to a sealed access port on a wall of a cyclotron chamber (not shown). Meanwhile, the flange 82′ on the target entrance port 82 enables coupling of a seal clamp 90 onto an airlock 85 attached to the flange 82′. Each flange 82′, 83′, can be flat on both sides or one side can have a beveled edge. The target entrance port 82 enables insertion of the held target carrier 50 into the gate valve 81, and the target exit port 83 enables the held target carrier 50 to protrude outside the airlock assembly 80 into the cyclotron chamber for subsequent irradiation of the target material 53.

To facilitate sealing of the airlock assembly 80, the airlock 85 includes an adapter centering and sealing ring 86 disposed at an entrance opening of the target entrance port 82. An airlock adapter 87 is mounted to the adapter centering and sealing ring 86 where the adapter centering and sealing ring 86 ensures the airlock adapter 87 is properly centered with the entrance opening of the target entrance port 82. An airlock seal 88 is seated within an annular groove on the airlock adapter 87. In use, the airlock seal 88 seals around the outer diameter of the outer tube 71 as the loader arm 70 pushes the held target carrier 50 into the gate valve 81. Some or all the components of the airlock 85, such as the adapter centering and sealing ring 86 and the airlock adapter 87, can be provided as integral or separate components of the airlock assembly 80.

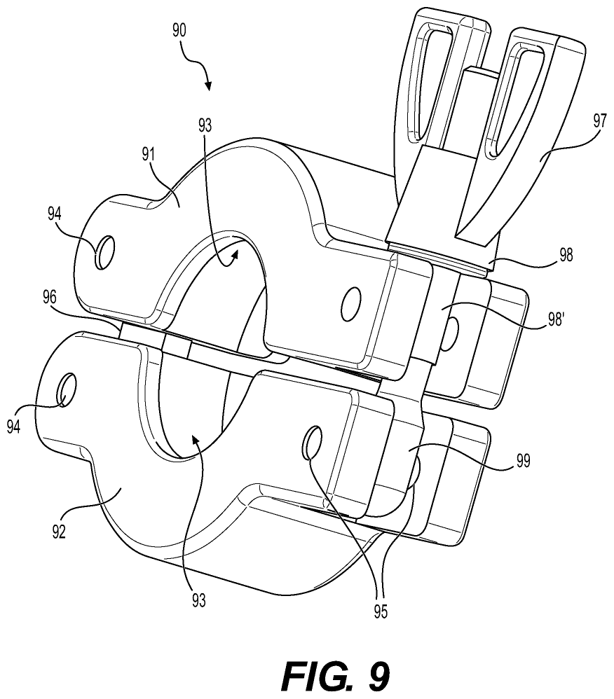

To maintain the sealing integrity of the airlock assembly 80, the airlock assembly 80 includes the seal clamp 90 detachably mounted to the flange 82′ and the airlock 85. As best seen in FIGS. 8 and 9, the seal clamp 90 is configured as a pair of oppositely disposed first clamp member 91 and second clamp member 92, also referred to as clamp members 91, 92, pivotally connected to each other. An example of a suitable seal clamp 90 that can be used or adapted for use is a KF flange.

Each clamp member 91, 92 is desirably identical, and the following uses the same reference numbers for common features for brevity and conciseness unless otherwise indicated. With reference to the first clamp member 91, the clamp member 91 includes a curved central section and a forked pivot section extending from opposite ends of the curved central section, which together forms a generally C-shape. A curved, inner capture channel 93 extends along the inner side of the curved central section following the curvature of the same. The sides of the capture channel 93 is desirably beveled to conform to the general outline of components captured within the capture channel 93, such as the airlock 85 and the back face of the flange 82′ as shown in FIG. 8.

An elongate hinge member 96 is pivotally mounted to one end of each clamp member 91, 92 at their respective forked pivot sections with pivot pins 94. The hinge member 96 enables the clamp members 91, 92 to pivot toward and away from each other. The hinge member 96 is desirably a generally rectangular plate with the pivot pins 94 extending orthogonally at opposite ends of the rectangular plate. The pivot pins 94 can be secured to the clamp members 91, 92 in any manner known in the art, such as with fasteners, rivets, and the like.

A clamping screw 97 has one end pivotally coupled to one of the other forked pivot sections on the clamp member 91, 92. In an embodiment, the clamping screw 97 is desirably a thumbscrew with a frustoconical head 98 where the base of the head 98 has a given diameter large enough to engage the forks of a forked pivot section. An elongate screw sleeve 98′ extends downwardly from the base of the head 98, and the screw sleeve 98′ has a given diameter that fits between the forks of a forked pivot section, preferably with suitable tolerance for unhindered movement of the screw sleeve 98′ therebetween. The screw sleeve 98′ includes internal threads engaged with threads on an elongate bolt 99 (threading not shown). The bolt 99 is pivotally connected to the other forked pivot section of the second clamp member 92 with a pivot pin 95. As with the pivot pins 94, the pivot pin 95 can be secured to the clamp member 92 in any manner known in the art, such as with fasteners, rivets, and the like. Selective rotation of the thumbscrew in either rotary direction facilitates corresponding raising or lowering of the head 98 along the length of the bolt 99 to thereby lengthen or shorten, respectively, an effective length of the clamping screw 97.

In use, the clamping screw 97 is loosened to lengthen the effective length of the clamping screw 97 such that it provides clearance for pivoting the head 98 over the opposite forked pivot section of the first clamp member 91. When the head 98 is thus positioned, the clamping screw 97 is tightened so that the base of the head 98 engages the forks of the opposite forked pivot section. Further tightening force the forked pivot sections engaged/connected to the clamping screw 97 to pivot towards each other to thereby clamp objects captured between the clamp members 91, 92. By this construction, the seal clamp 90 preserves sealing integrity by ensuring the airlock 85 is properly seated and aligned during repeated processing of plural target carriers 50. Though the above describes an example of a seal clamp 90, it is to be understood that other flanges and clamping mechanisms can be used depending on application and use and should not be construed in a limiting sense.

The atmosphere control port 84 is configured to be coupled to an air pump (not shown) for selective evacuation of air out of the gate valve 81 or introduction of air into the gate valve 81. Typically, the particle beams of a cyclotron are introduced into the cyclotron chamber under vacuum. It is imperative to maintain the vacuum state of the chamber in order to prevent high RF voltage breakdown and loss of charged particles acceleration due to molecular collisions with residual gases. To prevent introduction of such residual gases during the process of pushing the held target carrier 50 into the cyclotron chamber, the airlock assembly 80 serves as a prep station for acclimating the environment around the target carrier 50 to that of the environment in the cyclotron chamber prior to introducing the target carrier 50 into the cyclotron chamber for irradiation.

In use, the gate valve 81 is normally closed and the target carrier 50 is pushed into the gate valve 81. The loader arm 70 is still connected to the target carrier 50, and the portion of the loader arm 70 penetrating into the airlock 85 is sealed by the same. The air inside the gate valve 81 is evacuated through the atmosphere control port 84 to create vacuum. Once the desired vacuum has been established, the gate valve 81 is opened and the held target carrier 50 is pushed further until it protrudes into the cyclotron chamber through the target exit port 83. After irradiation of the target material 53 on the target carrier 50, the held target carrier 50 is retracted, the gate valve 81 is closed, and ambient atmosphere is reestablished by pumping air back into the gate valve 81 through the atmosphere control port 84. In this manner, the airlock assembly 80 isolates the target carrier 50 to be irradiated so as to prepare the same for the irradiation process.

After irradiation, the irradiated target material 53 must be processed to produce and collect radioisotopes. To facilitate dissolution of the target material 53, the solid target irradiator system 10 includes the dissolution assembly 100. The dissolution assembly 100 provides an in-situ processing of the irradiated target material 53 which eliminates handling and transport of the same to a remote processing station or site as in some conventional irradiator systems.

As best seen in FIGS. 1, 7, and 10-17, the dissolution assembly 100 includes a dissolution housing 101, generally a rectangular block in shape, coupled to a pneumatic cylinder 104. The pneumatic cylinder 104 includes a reciprocating piston rod 104′ directly connected to the dissolution housing 101 such that selective actuation of the pneumatic cylinder 104 raises or lowers the piston rod 104′ to facilitate corresponding selective raising and lowering of the dissolution housing 101. The pneumatic cylinder 104 can also be any actuator configured from mechanical, electrical, or electromechanical actuators depending on application and use and should not be construed in a limiting sense. The dissolution assembly 100 is mounted to the base 11 by a securing nut 104″ between the target carrier feeding assembly 20 and the airlock assembly 80, and the dissolution assembly 100 is selectively raised to be in the path of travel of the connected target carrier 50 and selectively lowered to clear this path of travel.

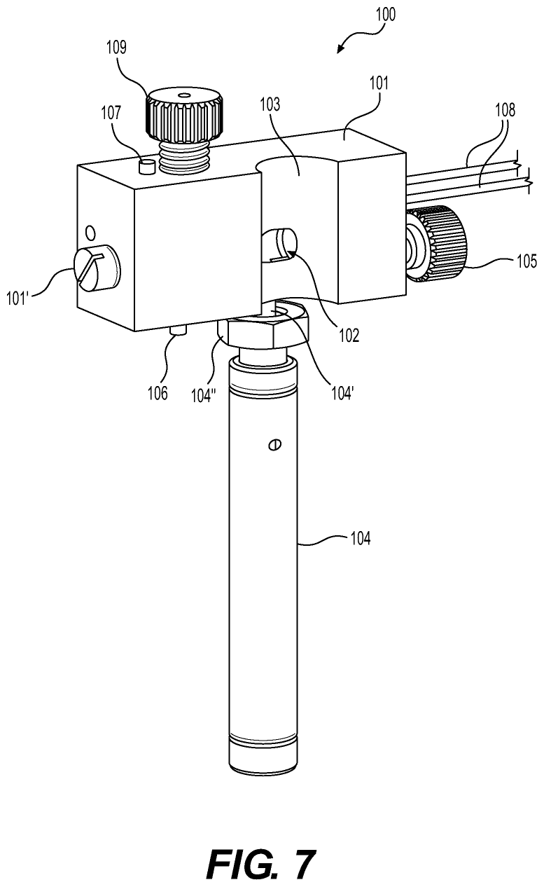

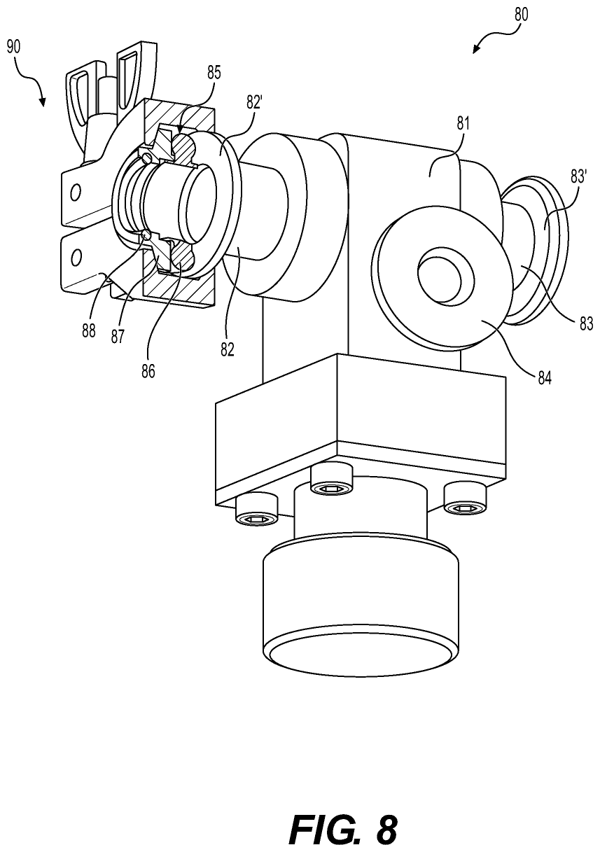

The dissolution housing 101 includes an interior chamber or cavity 102 (part of which is shown in FIG. 7 by reference number 102) for holding dissolution chemicals. An elongate, vertical target reception groove 103 is formed on a rear side of the dissolution housing 101. The target reception groove 103 is desirably a generally U-groove with a curved profile extending from top to bottom of the dissolution housing 101. The curvature of the target reception groove 103 is configured to match the curvature of the front face 52 on a target carrier 50 so as to selectively seat and seal the irradiated target carrier 50 thereon. Additionally, a part of the cavity 102 is exposed in the target reception groove 103 at the level of the target material 53 on the seated and irradiated target carrier 50, which enables dissolution chemicals to interact and chemically dissolve the target material 53 on the front face 52 of the target carrier 53. A plug 101′ is coupled to a side of the dissolution housing 101 to seal the cavity 102.

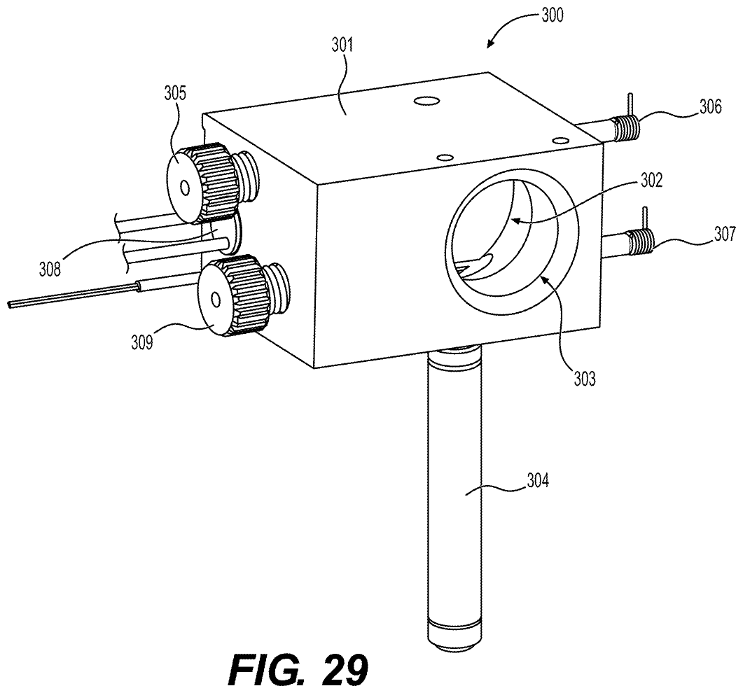

To facilitate the dissolution process, the dissolution assembly 100 includes a dissolution chemicals supply fitting 105 disposed on a side of the dissolution housing 101. This dissolution chemicals supply fitting 105 enables injection of chemicals or solution, such as HCL, required for the dissolution process through an attached transfer tube. A lower liquid level sensor 106 disposed on the bottom of the dissolution housing 101 and an upper liquid level sensor 107 disposed at the top of the dissolution housing 101 monitors the level of solution contained in the cavity 102 so as to ensure a suitable, predetermined volume of solution is maintained in the cavity 102 during the dissolution process. A heater in the form of heating lines 108 extending from a heating element (not shown but see FIG. 29) is coupled to the dissolution housing 101 to selectively heat the cavity 102 and solution contained therein. The heater promotes and optimizes chemical activity due to the addition of thermal energy. A gas tube fitting 109 is desirably disposed at the top of the housing to selectively introduce compressed gas and promote movement of the dissolution chemicals within the cavity 102 during a dissolution cycle. The ingress of compressed gas also assists in flushing the dissolution chemicals back through the dissolution chemicals supply fitting 105 after the dissolution cycle for subsequent collection of the radioisotopes produced by the dissolution process.

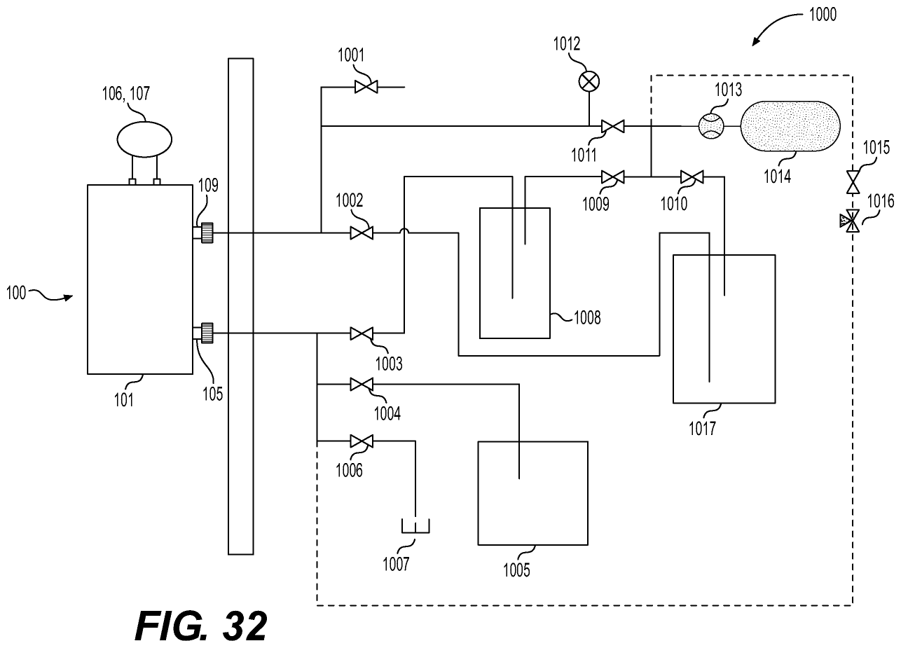

Referring to FIG. 32, this figure depicts an exemplary in-situ dissolution of the radioisotopes from the irradiated target material 53. This process occurs when the irradiated target carrier 50 is seated and sealed.

In a dissolution system 1000 shown in FIG. 32, the dissolution cycle begins with the irradiated target carrier 50 seated and sealed as noted above. A dissolution solvent tank 1008 contains a supply of dissolution chemical or solvent in liquid form, such as HCL, and a compressed gas tank 1014 containing pressurized gas provides the motive force for moving fluids throughout the dissolution system 1000. A pressure regulator 1013 is coupled to the compressed gas tank 1014 to maintain the outgoing gas pressure within suitable predefined levels.

The dissolution solvent is injected into the dissolution assembly 100 via the dissolution chemicals supply fitting 105 by opening a vent valve 1001, a dissolution gas valve 1009, and a dissolution liquid valve 1003 to force pressurized gas into the dissolution solvent tank 1008 at a predefined pressure. The open vent valve 1001 prevents backpressure that would hinder fluid movement throughout the system. Other surrounding valves directly in line with the compressed gas tank 1014, such as a compressed gas valve 1011 and a wash gas valve 1010 are normally closed during this dissolution solvent injection process to confine the gas flow toward the dissolution solvent tank 1008. Similarly, other valves in the flow of the dissolution solvent such as a wash liquid valve 1002, a collection liquid valve 1004, and a drain liquid valve 1006 are also normally closed. The incoming pressurized gas forces the dissolution solvent from the dissolution solvent tank 1008, and the dissolution solvent flows through the dissolution liquid valve 1003 to introduce the dissolution solvent into the cavity 102. The dissolution solvent continues to flow into the cavity 102 until a desired level/volume of the solvent has been reached, which is being monitored by the lower liquid level sensor 106 and the upper liquid level sensor 107. At this point, both the dissolution gas valve 1009 and the dissolution liquid valve 1003 are closed to stop the flow of solvent into the dissolution assembly 100. Thereafter, the dissolution solvent remains in the cavity 102 for a predetermined period of time to allow completion of the chemical reaction between the dissolution solvent and the irradiated target material 53.

Upon cessation of the dissolution solvent injection, the compressed gas valve 1011 can be opened for a predetermined period of time and closed at the end of this period to inject air into the cavity 102 via the gas tube fitting 109 to agitate the dissolution solvent in the cavity 102. A pressure sensor 1012 is associated with the compressed gas valve 1011 to monitor the pressure thereof. Alternatively, a separate gas agitation valve 1015 can be activated instead to pass the pressurized gas through a needle valve 1016 for finer control of pressure and gas outflow towards the cavity 102 via the dissolution chemicals supply fitting 105 for similar solvent agitation effect.

Once the chemical reaction has ended, the vent valve 1001 is closed and both the collection liquid valve 1004 and the compressed gas valve 1011 are opened. This introduces pressurized gas into the cavity 102 via the gas tube fitting 109 to flush the dissolved radionuclide material through the collection liquid valve 1004 to be stored in a collection tank 1005. This radionuclide material can then be separated into pharmaceutical radioisotopes using separation chemistry.

Though the dissolution cycle can end here, it is desirable for the target carrier 50 (or spent target carrier 50′ since the target material 53 has been removed) to undergo a wash cycle prior to disposal thereof. In that regard, the dissolution system 1000 includes a wash tank 1017 containing, e.g., water or any other fluid suitable for washing the spent target carrier 50′. The wash cycle begins by opening the wash gas valve 1010, wash liquid valve 1002, drain liquid valve 1006, and the vent valve 1001. The remaining valves are closed. The open wash gas valve 1010 forces pressurized gas into the wash tank 1017 to force the water through the wash liquid valve 1002 and into the cavity 102 through the gas tube fitting 109. The water circulates in the cavity 102 thereby rinsing and cleaning the front face 52 and other exposed areas of the spent target carrier 50′. The water exits the cavity 102 through the dissolution chemicals supply fitting 105 and through the drain liquid valve 1006 to be disposed of through a drain 1007. The open vent valve 1001 enables excess wash water to be vented. At the end of the wash cycle, all the valves are closed in preparation for the next dissolution cycle.

The above dissolution system 1000 is only an example. Other dissolution systems can also be used taking advantage of suitable couplings for the dissolution assembly 100.

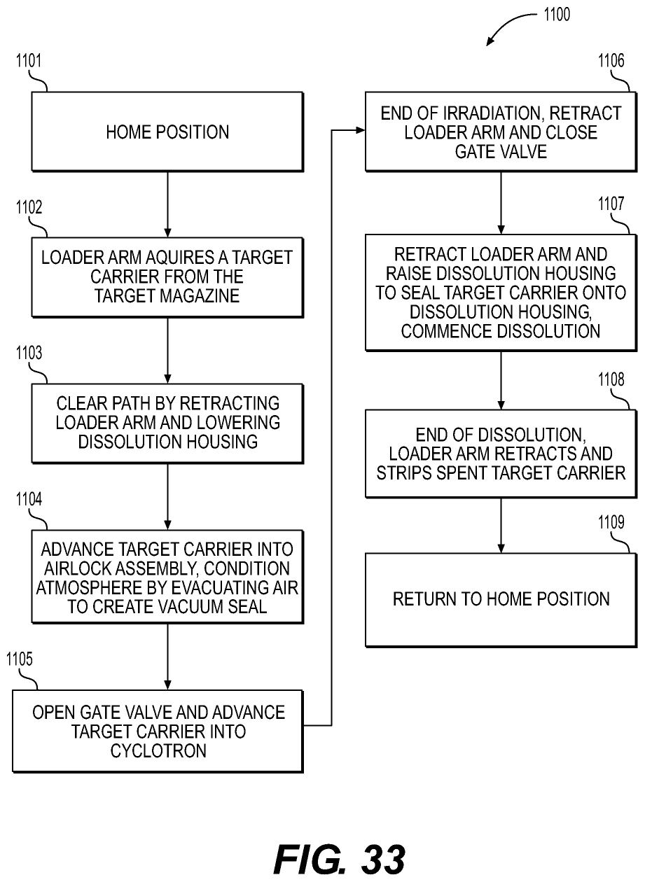

Having thus described an embodiment of the solid target irradiator system 10, the following describes the operational steps the solid target irradiator system 10 undergoes to process a given stack of target carriers 50 with reference to FIGS. 10-17 and 33. It is noted that FIGS. 10-17 do not include all the reference numbers previously described. They have been limited to features that can be seen in the drawing and relevant to the operational step for brevity and clarity. FIG. 33 shows a corresponding schematic flow diagram of the operational steps 1100 followed by the solid target irradiator system 10.

Referring to FIGS. 10 and 33, the solid target irradiator system 10 is in a home or ready state as indicated by step 1101. In this state, the target magazine 21 is fully loaded with a stack of target carriers 50 to be processed. The loader arm 70 is fully retracted where the manipulator carriage 65 abuts the first guide support bracket 61, and the dissolution housing 101 of the dissolution assembly 100 is in a raised position. It can be seen from this view that the loader arm 70, the pass-through hole 26, the dissolution housing 101, and features such as the target exit port 83 on the airlock assembly 80 are all coaxially aligned along the common target processing axis 13.

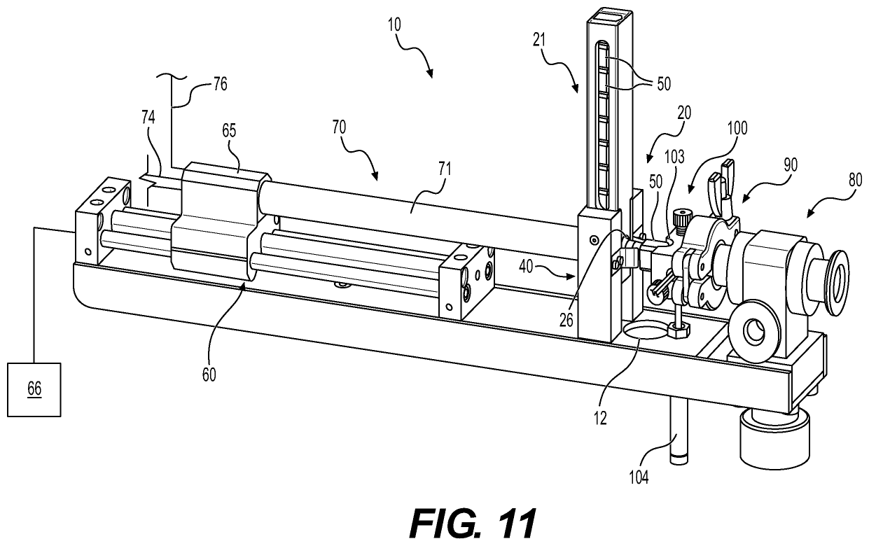

Referring to FIGS. 11 and 33, the solid target irradiator system 10 is in a target carrier acquisition state as indicated by step 1102. In this state, the loader arm 70 is advanced by the manipulator carriage 65 through the pass-through holes 26 on the target magazine 21 to acquire a target carrier 50 from the bottom thereof and press the target carrier 50 against the target reception groove 103. This pressing of the target carrier 50 enables commencement of coolant flow through the inner tube 72 and apply fluid pressure to thereby expand the thin wall of the second frustoconical section 79 of the target plug end 73 and establish a firm grip on the target carrier 50.

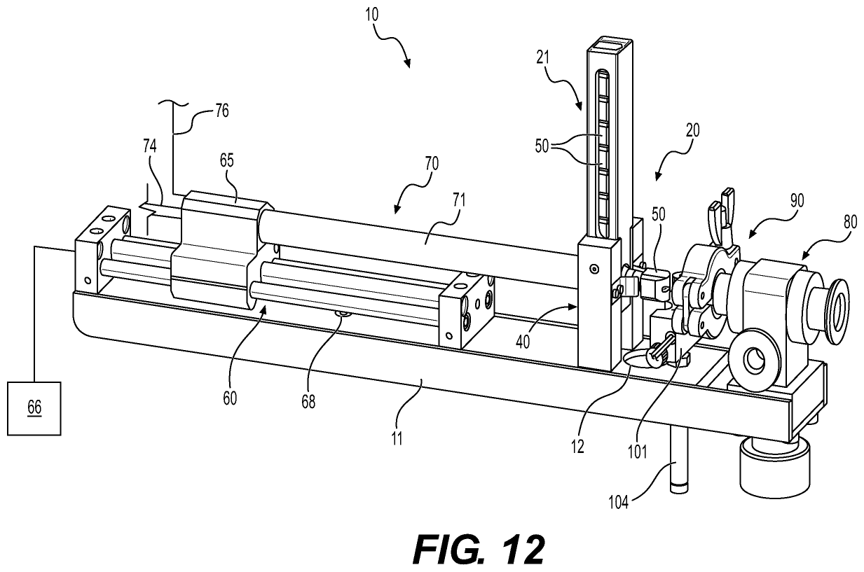

Referring to FIGS. 12 and 33, the solid target irradiator system 10 is in a path clearing state as indicated by step 1103. In this state, the loader arm 70 is retracted a short distance till the manipulator carriage 65 reaches the first carriage stop 67 and fixed in position. This frees the engagement between the held target carrier 50 and the target reception groove 103 enabling the dissolution housing 101 to be lowered by the pneumatic cylinder 104. The lowered dissolution housing 101 exposes the target entrance port 82 on the airlock assembly 80 and clears the path of travel for the held target carrier 50 along the common target processing axis 13 towards the same. Coolant is still circulating through the loader arm 70 and maintaining the firm grip on the held target carrier 50.

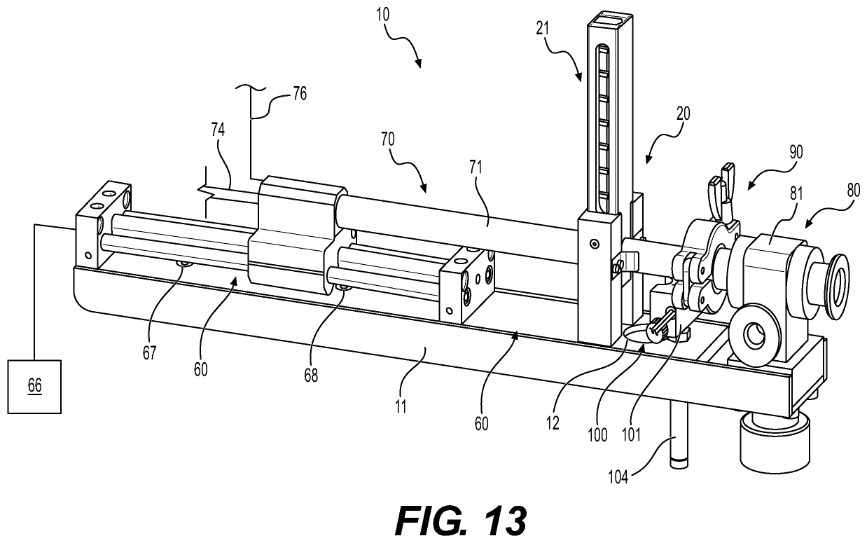

Referring to FIGS. 13 and 33, the solid target irradiator system 10 is in an atmosphere conditioning state as indicated by step 1104. In this state, the loader arm 70 is advanced by the manipulator carriage 65 until it reaches the second carriage stop 68 and fixed in position. This pushes the held target carrier 50 and a front portion of the loader arm 70 into the airlock assembly 80 and sealed therein by the airlock 85. The gate valve 81 is closed, and the air inside is evacuated through the atmosphere control port 84 to create a vacuum seal. This conditions the atmosphere so that both the gate valve 81 and the cyclotron chamber are in vacuum. Then the gate valve 81 is opened to permit subsequent advancement of the held target carrier 50. Coolant is still circulating through the loader arm 70 and maintaining the firm grip on the held target carrier 50.

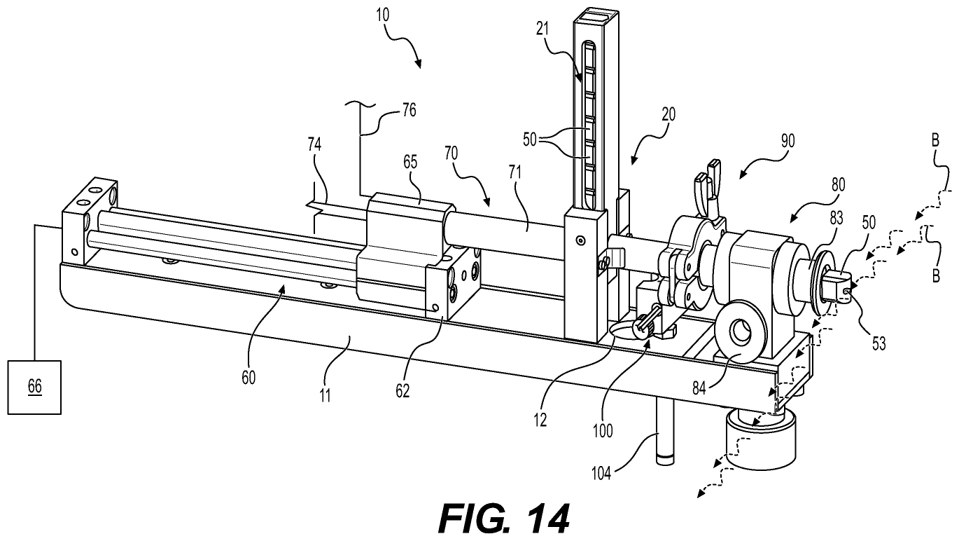

Referring to FIGS. 14 and 33, the solid target irradiator system 10 is in a target material irradiation state as indicated by step 1105. In this state, the gate valve 81 has been opened, and the loader arm 70 is advanced until the manipulator carriage 65 abuts the second guide support bracket 62. In this position, the held target carrier 50 has been advanced through the target exit port 83 into the cyclotron to expose the target material 53 for interception by radiation beams B and thereby irradiate the target material 53. The act of irradiation heats the target carrier 50 to a point where it can potentially destroy the target carrier 50 in the absence of a cooling solution. Thus, the coolant circulating through the loader arm 70 cools the target carrier 50 to prevent such an event while maintaining the firm grip thereon.

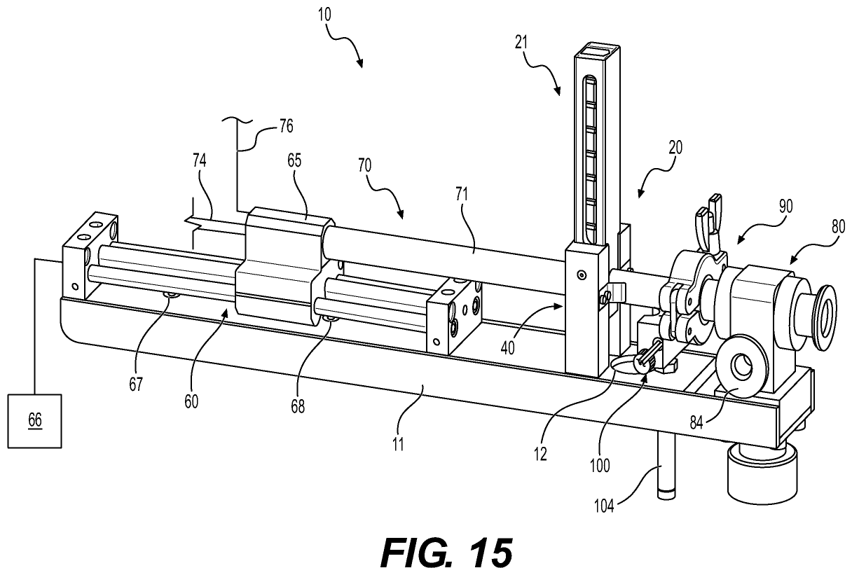

Referring to FIGS. 15 and 33, the solid target irradiator system 10 is in a post target material irradiation end state as indicated by step 1106. In this state, irradiation of the target material 53 has ended, and the loader arm 70 has been retracted by the manipulator carriage 65 until it reaches the second carriage stop 68 and fixed in position. The gate valve 81 is again closed, and air is reintroduced or vented into the gate valve 81 through the atmosphere control port 84 to reestablish ambient atmosphere conditions. Coolant is still circulating through the loader arm 70 and maintaining the firm grip on the held target carrier 50.

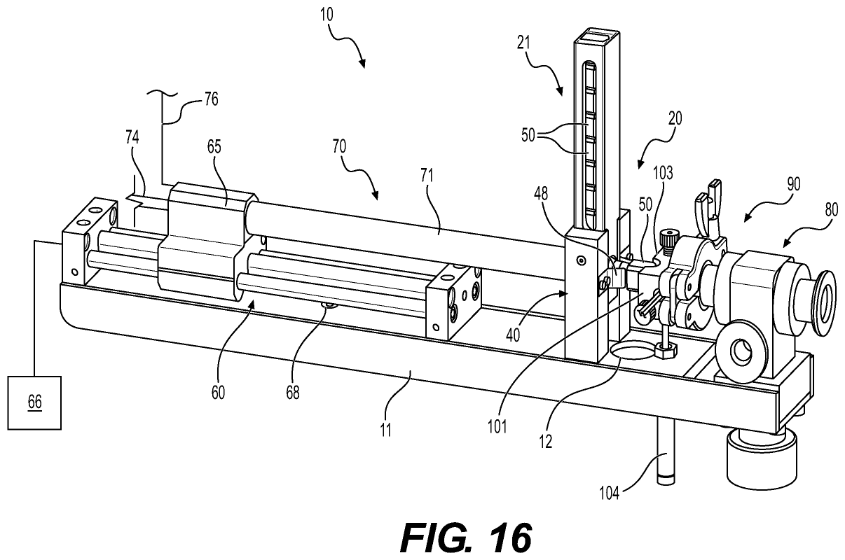

Referring to FIGS. 16 and 33, the solid target irradiator system 10 is in a dissolution process state as indicated by step 1107. In this state, the loader arm 70 is retracted till the manipulator carriage 65 reaches the first carriage stop 67. This provides space for raising the dissolution housing 101 by the pneumatic cylinder 104. Once raised, the loader arm 70 is advanced to seat and seal the held target carrier 50 against the target reception groove 103 on the dissolution housing 101. Dissolution of the irradiated target material 53 commences in the manner described above with respect to the dissolution system 1000. At the commencement of the dissolution process, the coolant flowing through the loader arm 70 can be shut off since the pressing position of the loader arm 70 may provide suitable pressure to maintain the sealed seating. However, it is more desirable to maintain the coolant circulation to ensure the firm grip on the held target carrier 50 is sustained.

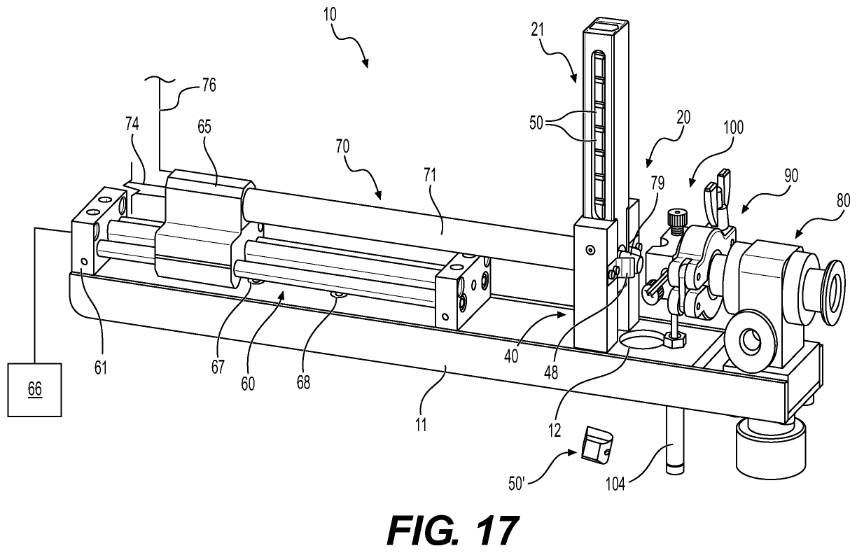

Referring to FIGS. 17 and 33, the solid target irradiator system 10 is in a post dissolution process end state as indicated by step 1108. In this state, the dissolution process has ended resulting in a spent target carrier 50′ that no longer carries the irradiated target material 53. Coolant circulation in the loader arm 70 has been shut off, and the loader arm 70 is retracted back towards the first guide support bracket 61. During this retraction process, the spent target carrier 50′ is stripped from the second frustoconical section 79 of the target plug end 73 by the target stripper 48 engaging the rear of the spent target carrier 50′ during movement thereof. The spent target carrier 50′ is allowed to fall by gravity through a target disposal hole 12 next to the target magazine support subassembly 40 on the base 11 for later disposal.

An alternative arrangement for the target strippers 48, 48 can be provided to facilitate stripping of the spent target carrier 50′. In an embodiment, each target stripper 48 can be configured as flat springs instead of angled with each mounted to a corresponding support member 41 in spaced relation with each other, which forms a gap between the free or loose ends of the target strippers 48, 48. This gap is desirably equal to or less than the diameter of the outer tube 71. By this construction, the acquisition and passage of the held target carrier 50 and the loader arm 70 towards the dissolution housing 101 will bend the free ends of the target strippers 48, 48 outward and maintain that condition until the retraction process mentioned above. During retraction, the free ends will engage the back of the spent target carrier 50′ to strip the same off the tip of the loader arm 70, and further retraction will disengage or free the free ends and allow the target strippers to return to the normally flat state.

Referring to FIGS. 10 and 33, the solid target irradiator system 10 is in a return home state as indicated by step 1109. It is noted that reference to FIG. 10 is illustrative in that this return home state is much the same as that shown in FIG. 10. However, in this return home state, full retraction of the loader arm 70 till the manipulator carriage 65 abuts the first guide support bracket 61 clears the tip of the loader arm 70 from the target magazine 21. This releases the next target carrier 50 in the target magazine 21 and allow it to drop in place. Then the operational steps as previously described are repeated.

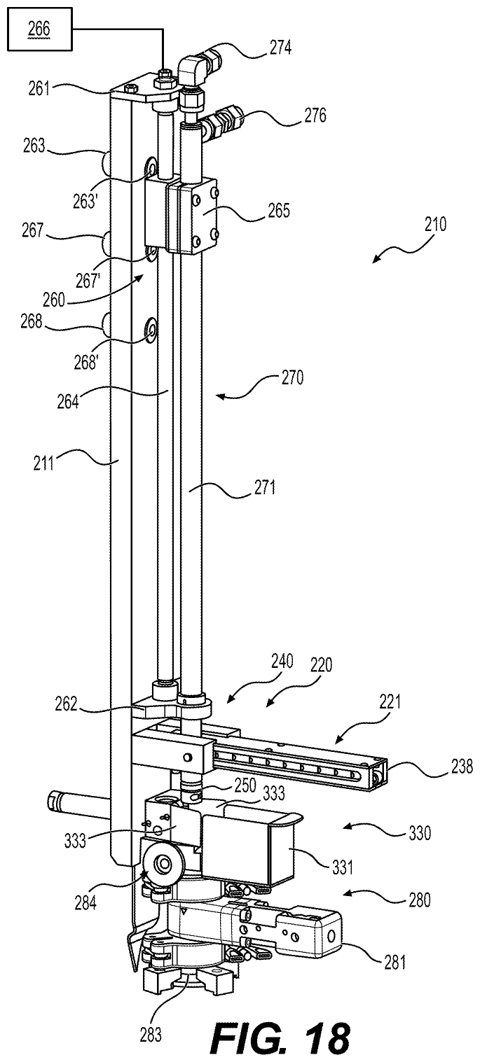

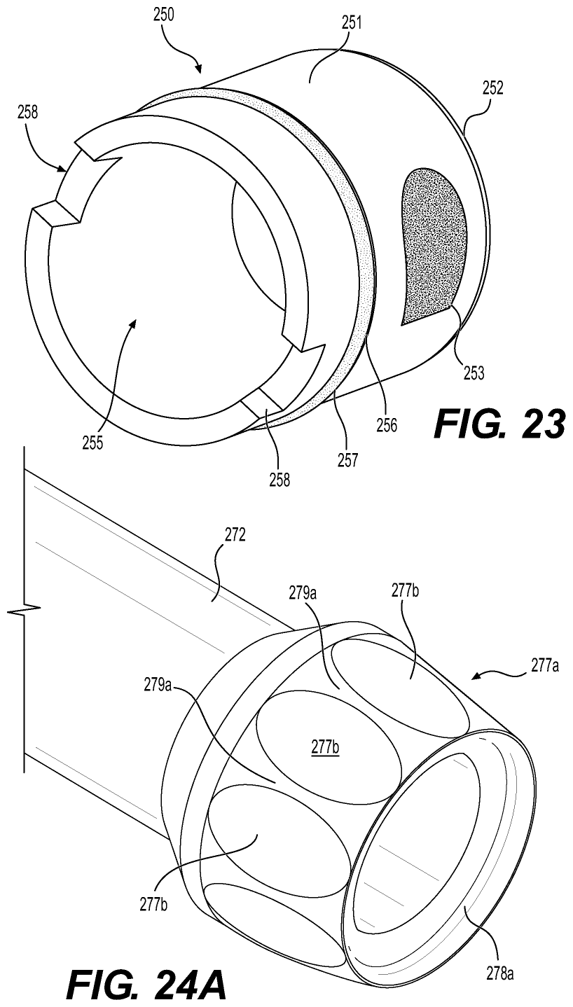

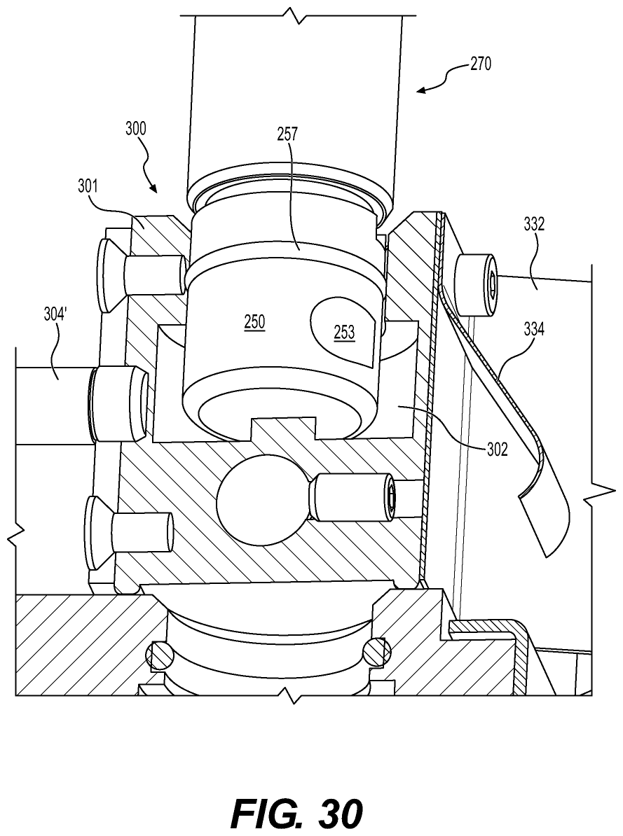

An alternative solid target irradiator system 210 is shown in FIGS. 18-30. In this embodiment, the solid target irradiator system 210 is configured to operate in a vertical orientation as opposed to the horizontal orientation in the previous embodiment. In most respects the operation, function, and assemblies are substantially the same between the two embodiments. In light of this, the following will generally center on the variations and follow the general reference number convention utilized in describing the previous solid irradiator system 10.

The solid target irradiator system 210 includes a base 211; a target carrier feeding assembly 220 coupled to the base 211 for sequentially feeding individual target carriers 250 of the plurality of target carriers 250; a target loader assembly 260 coupled to the base 211 for selectively engaging each target carrier 250 for subsequent advancement and retraction of an engaged target carrier 250 through the solid target irradiator system 210; a selectively moveable dissolution assembly 300 coupled to the base 211 and downstream from the target loader assembly 260 for selective engagement with the target carrier 250 and dissolution of target material 253 thereon; and an airlock assembly 280 coupled to the base 211 to prepare the target carrier 250 for subsequent irradiation.

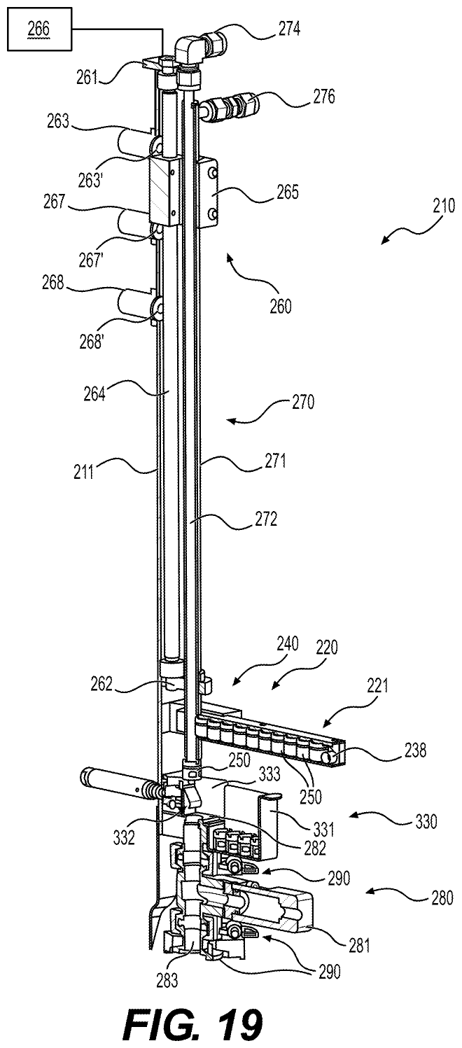

As shown in FIGS. 18 and 19, the base 211 is desirably an elongate, rectangular platform, beam, or member supporting various processing assemblies thereon. The target loader assembly 260 is mounted on one end of the base 211 and the airlock assembly 280 is mounted to the other end of the base 211. The target carrier feeding assembly 220 is mounted on the base 211 between the target loader assembly 260 and the airlock assembly 280 to enable the target loader assembly 260 load a select target carrier 250 to the airlock assembly 280. The dissolution assembly 280 is operatively mounted to the base 211 between the target carrier feeding assembly 220 and the airlock assembly 280. The order of these assemblies on the base 211 enables efficient processing of the target material for irradiation, dissolution thereof, and collection of radioisotopes from the dissolution process with minimal user or manual interaction, which substantially reduces potential instances of undesirable radiation exposure and other complications, thereby increasing general safety for the user.

The solid target irradiator system 210 is provided with the target carrier feeding assembly 220 to facilitate relatively swift processing of a set of a plurality of targets 250. As best seen in FIGS. 18-22, the target carrier feeding assembly 220 includes a selectively removable target cassette or magazine 221 slidably mounted to a target magazine support subassembly 240.

The target magazine 221 is substantially the same as the target magazine 21. The target magazine 221 includes a front panel 222, a back panel 223 spaced from the front panel 222, and a target holder bracket or cradle 228 sandwiched between the front and back panels 222, 223. When assembled, the target holder cradle 228 holds a stack or plural target carriers 250 within a U-shaped, open channel 232 in the target holder cradle 228. The front and back panels 222, 223 close opposing sides of the open channel 232 to form an elongate recess or receptacle for receiving/loading the stack of target carriers 250 therein.

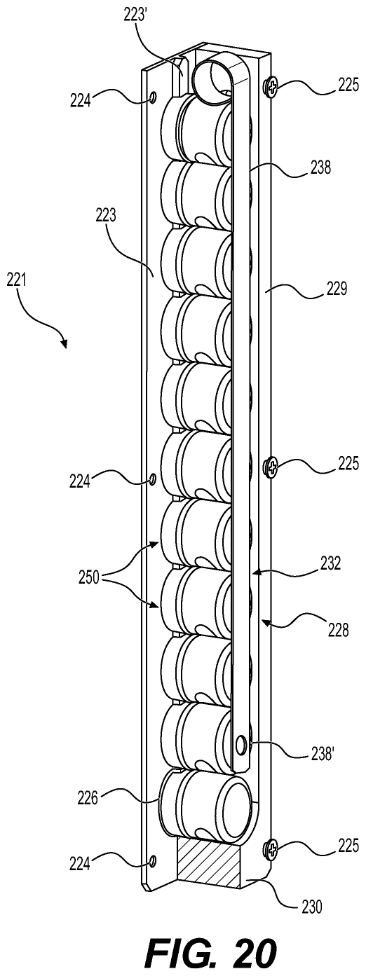

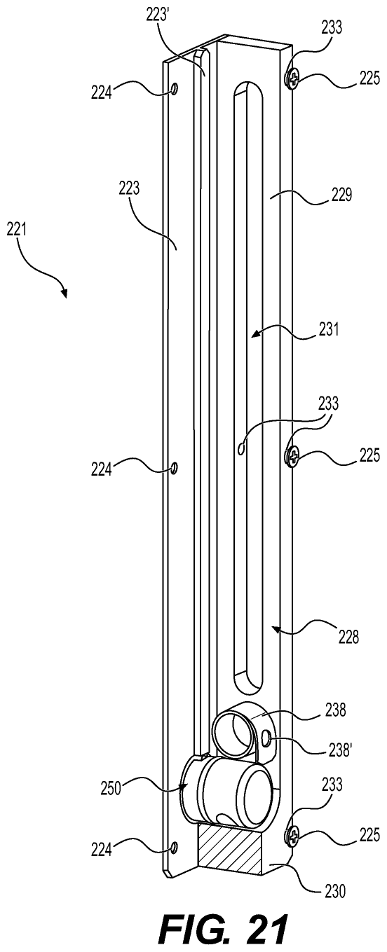

In an embodiment, the front and back panels 222, 223 are configured with some common features but are desirably different to accommodate additional features for aligned loading of target carriers 250 and retention of the stack of target carriers 250 within the target magazine 221. As best seen in FIGS. 20 and 21, the back panel 223 is desirably an elongate plate with a plurality of mounting holes 224 disposed near the vertical sides, and a desirably circular, pass-through hole 226 formed near a bottom portion of the back panel 223. An elongate alignment tongue, protrusion, tab, or ridge 223′ extends from the top of the back panel 223 towards the bottom and terminates at the pass-through hole 226. The alignment ridge 223′ protrudes into the interior of the target magazine 221 and serves to assist in aligning the target carriers 250 during loading, the details of which will be further described below.

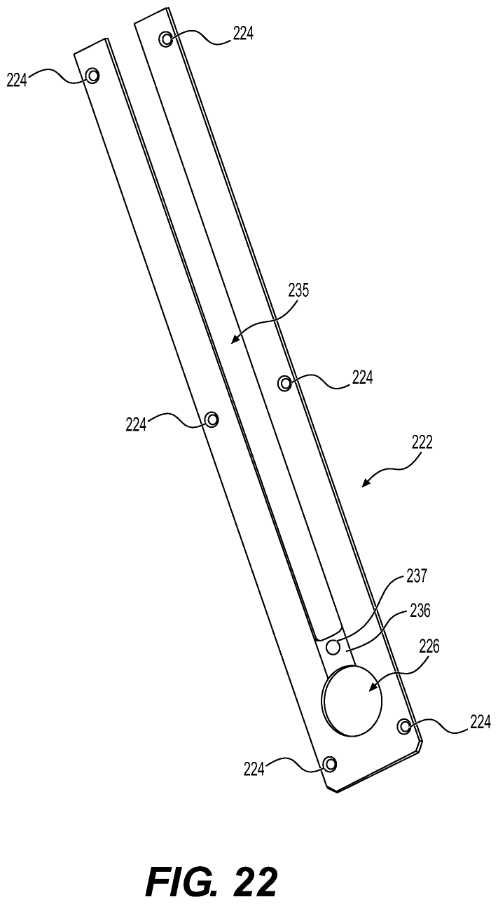

As best seen in FIG. 22, the front panel 222 is configured as an elongate plate with an elongate central slot 235 extending from the top of the front panel 222 towards the bottom. A plurality of mounting holes 224 are disposed near the vertical sides, and a desirably circular, pass-through hole 226 is formed near a bottom portion of the front panel 222. A lower bridge section 236 divides the slot 235 from the pass-through hole 226 on the front panel 222. A spring mount or anchor tab 237 extends inwardly from the bridge section 217.

The target holder cradle 228 is substantially the same as the target holder cradle 28. As such, the target holder cradle 228 is desirably a U-shaped unitary member with a pair of spaced elongate leg sections 229, 229 interconnected by a lower bridge section 230. The leg sections 229, 229 and the bridge section 230 form the elongate open channel 232 in the space between leg sections 229, 229 and the bridge section 230. The bridge section 230 desirably includes an upper curved surface that conforms to an outer surface of the target carrier 250. This curved surface of the bridge section 230, however, can be configured to have any shape that substantially conforms to the target carrier 250 or otherwise holds the target carrier 250 in a relatively secure manner thereon. Each leg section 229, 229 has front and back edges provided with a plurality of panel mount holes 233 for securing the front panel 222 and the back panel 223 with fasteners 225, such as screws, bolts, and the like.

Each leg section 229, 229 is desirably provided with an elongate slot 231 formed thereon. These slots 231 serve as a window for viewing the number of target carriers 250 contained within the target magazine 221 for a user to determine when a refill of target carriers 250 is required, to visually inspect the target carriers 250, and/or to access target carriers 250 during loading of the target magazine 221. These slots 231 also reduce the overall weight of the target holder cradle 228.

As noted above, the solid target irradiator system 210 is configured to operate in a vertical orientation. This orientation, however, places the target magazine 221 in a horizontal orientation. The horizontal orientation of the target magazine 221 eliminates gravity as a force that assists feeding subsequent target carriers 250 into position for selective loading by the target loader assembly 260. To facilitate forced feeding of the target carriers 250, the target magazine 221 is provided with a biasing means acting on the stack of target carriers 250 that push the stack towards the pass-through holes 226. The biasing means is desirably a constant force coil spring 238, also referred to as a spring 238, that has a bias to coil back when unwound. The spring 238 includes an anchor hole 238′ at one end to facilitate anchoring this end of the spring 238 to the spring anchor tab 237 on the front panel 222 and fixed thereon with fasteners, rivets, and the like.

In use, the user loads a stack of target carriers 250 into the assembled target magazine 221. To secure this stack inside the target magazine 221, the user uncoils the spring 238 to a fully uncoiled state. Uncoiling of the spring 238 extends the length of the spring 238 so that it spans past the height of the stack. The user places the remainder of the free or unanchored end of the spring 238 over the top of the topmost target carrier 250 and releases the spring 238 so that this remainder coils back and rests on top of the topmost target carrier 250. This action captures the stack of target carriers 250 between the ends of the spring 238 to thereby secure the stack in the target magazine 221 and provide a bias that forces the stack down the length of the target magazine 221. In an embodiment, the front panel 222 can be configured as an elongate, uninterrupted plate much like the front panel 22 with the exception of the spring anchor tab 237 disposed thereon.

Other types of biasing means and/or pushing mechanisms can be used to force feed the stack of target carriers 250, such as elastic bands, pneumatic pushers, and the like. Additionally, similar biasing means can be applied to the target magazine 21. Furthermore, some or all of the parts, such as the front panel 222, back panel 223, the target holder cradle 228, and/or sections thereof, can be integral elements. Such an integral target magazine 221 can be constructed via casting, molding, machining, 3D printing, and the like depending on the materials for the construction.

The target magazine 221 is secured to the base 211 by a target magazine support subassembly 240. It is of same construction as the target magazine support subassembly 40, and the same parts herein will be referenced by similar reference numbers in the “200” series. Reference is made to the previous embodiment for additional details.

As best seen in FIGS. 18-21, 23, and 25, the target carrier 250 includes a generally cylindrical target body 251 with a flat front end or face 252. The target body 251 serves as a substrate for deposition of target material 253, the target material 253 being the material to be irradiated and processed to obtain radioisotopes. Some examples of materials for the target body 251 include copper, silver, or any other thermoconductive material, and examples of target material 253 include zinc, nickel, and other materials that can be irradiated and undergo a dissolution process for radioisotope production. In an embodiment, the target material 253 is deposited onto the curved side of the target body 251 near the face 252 so that the tip portion of the target carrier 250 with the target material 253 thereon will be presented and subjected to irradiation during operation of the solid target irradiator system 210. The side of the target body 251 can include a shaped recess for the target material 253 or a relatively thin layer of target material 253 can be deposited onto the side. The shape of the target material 253 is desirably configured to correspond to a projected shape of a circular particle beam incident on the curved cylindrical surface of the target body 251.

The rear end of the target carrier 250 is provided with a generally frustoconical shaped mount recess or socket 255 for selective coupling with the target loader assembly 260. An annular groove 256 is formed near the base of the target body 251, and a target seal 257 is seated within the annular groove 256. The target seal 257 is desirably an O-ring, and during use, the target seal 257 seals the target carrier 250 within the dissolution assembly 300. The rear end of the target carrier 250 also includes a pair of diametrically opposed alignment notches 258 configured to align the target carrier 250 within the target magazine 221.

As mentioned previously, a uniform orientation of the stack of target carriers 250 is greatly desired to more efficiently process plural target carriers 250. The target carrier 250 simplifies such considerations with the alignment notches 258 engaging the alignment ridge 223′ on the back panel 223 during loading of the target magazine 221. This arrangement of the alignment notches 258 and the alignment ridge 223′ limits the target carrier 250 to two different aligned orientations, which can be adjusted by 180° rotations about the axis of the cylindrical target body 251 to switch between the two. This enables the user to quickly and easily load the target carriers 250 in a proper orientation such that the target materials 253 are facing the same direction at the same orientation.

To further expand on the proper orientation, even though the alignment notches 258 allow the target carrier 250 to be aligned in two different orientations, only one is correct and proper. When positioned inside the cyclotron chamber for irradiation, the target carrier 250 must be positioned at an orientation that aligns the target material 253 with the incoming particle beam so that only the full target material 253 is irradiated. The other orientation will expose a portion of the target carrier 250 without the target material 253. Thus, proper alignment and orientation of each target carrier 250 within the stack must be maintained, especially for the cylindrical shape of the target carrier 250, and the alignment notches 258 and the alignment ridge 223′ assist the user in facilitating this during loading thereof into the target magazine 221.

As best seen in FIGS. 18 and 19, the target loader assembly 260 includes a pair of spaced guide support brackets or a first guide support bracket 261 disposed on one end or rear end of the base 211 and a second guide support bracket 262 spaced from the first guide support bracket 261 downstream towards the opposite end or front end of the base 211. The first guide support bracket 261 and the second guide support bracket 262 are also referred to as guide support brackets 261, 262 for brevity. An elongate drive shaft or rod 264 is coupled to and extend between the guide support brackets 261, 262. A manipulator carriage 265 is coupled to the drive rod 264 and configured to move or travel between the guide support brackets 261, 262 in a selective, reciprocal manner. The drive rod 264 is desirably coupled to a driver 266, such as a servomotor, linear actuator, pneumatic actuator, and the like. Selective activation of the driver 266 facilitates corresponding selective reciprocal movements of the manipulator carriage 265 via its connection with the drive rod 264.

The target loader assembly 260 also includes a plurality of carriage stops to halt the manipulator carriage 265 at predefined points along the path of travel. These predefined points relate to processing positions of the target loader assembly 260 during use. In an embodiment, the target loader assembly 260 includes a first carriage stop 263, a second carriage stop 267 spaced a predefined distance from the first carriage stop 263 towards the second guide support bracket 262, and a third carriage stop 268 spaced from the second carriage stop 267 a predefined distance towards the second guide support bracket 262. Each first, second, and third carriage stops 263, 267, 268 are desirably selectively actuatable pneumatic cylinders that upon actuation, raises and lowers a respective piston rod 263′, 267′, 268′ to a desired height. The piston rods 263′, 267′, 268′ serve as stop abutments for limiting travel of the manipulator carriage 265. The carriage stops can also be configured from mechanical, electrical, or electromechanical actuators depending on application and use and should not be construed in a limiting sense.

An elongate manipulator or loader arm 270 is mounted to the manipulator carriage 265 to be carried thereby. The loader arm 270 extends from the manipulator carriage 265 towards the target carrier feeding assembly 220 and terminates at a distal, free-standing tip section or closed, target plug 273.

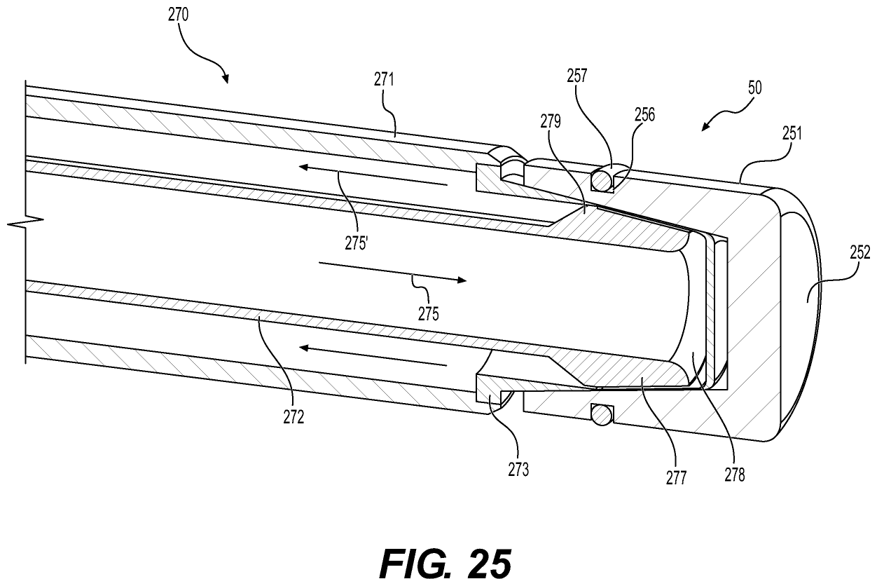

As best seen in FIGS. 18, 19, 24, and 25, the loader arm 270 includes an elongate, circular outer tube 271 and an elongate, concentric and circular, inner tube 272. In an embodiment, the outer tube 271 terminates to a closed distal end, and the inner tube 272 terminates to an open distal end. A coolant supply coupling 274 is coupled to a rear end the inner tube 272. The coolant supply coupling 274 selectively supplies coolant, for example fluid such as water or gas, through the inner tube 272 from the rear or back thereof to flow and exit out of the open end of the inner tube 272. The exiting coolant circulates within the space between the inner tube 272 and the outer tube 271 (indicated by coolant inflow arrows 275 and coolant outflow arrows 275′ in FIG. 25) to thereby cool objects in contact with the loader arm 270, more specifically an engaged target carrier 250. The circulating coolant exits the outer tube 271 through a coolant outflow coupling 276 coupled to the rear of the outer tube 271.

The target plug 273 may be an integral or a separate element with the outer tube 271, and it is configured to selectively engage a target carrier 250 at the bottom of the target magazine 221. To facilitate this engagement or coupling, the target plug 273 is desirably configured as a frustoconical cap extending from the distal end of the outer tube 271. The outer dimensions and shape of the target plug 273 closely match the inner dimensions and shape of the socket 255 on a target carrier 250 to facilitate a socket-and-plug type of connection. The base of the frustoconical cap has a given outer diameter desirably smaller than the outer diameter of the outer tube 271 where the difference substantially matches the thickness of the annular edge at the rear of the target carrier 250, this edge being the portion of the rear between the outer diameter of the target body 251 and the diameter of the socket 255. This correlation enables the outer surface of the target body 251 to be substantially flush with the outer surface of the outer tube 271.

A portion of a sidewall of the target plug 273 is provided with a relatively thin wall in the order of about 0.05 mm to 0.2 mm, more preferably about 0.1 mm. This thin wall provides a degree of flexibility to this portion of the target plug 273 such that fluid pressure from the incoming coolant through the inner tube 272 expands the thin wall to a degree for increased and pressurized grip inside the socket 255.

The distal end of the inner tube 272 includes a generally frustoconical-shaped nozzle head 277 with larger outer dimensions that conform with the inner dimensions at the tip section of the target plug 273. The inner diameter of the nozzle head 277 is the same as the inner diameter of the inner tube 272. The nozzle head 277 includes a fluted spout 278 at the open end of the nozzle head 277 to efficiently disperse exiting coolant through the space between the outer tube 271 and the inner tube 272 and thereby expand the thin wall in a more efficient manner.

While the above arrangement facilitates selective expansion in the same manner as with the loader arm 270, the nozzle head 277 also includes angularly spaced, radially extending contact tabs 279 for mechanically centering the inner tube 272 against the outer tube 271 and thereby centers the target plug 273 inside the socket 255. These contact tabs 279 are relatively small, and the spacing provides a desired cross section for optimal coolant velocity. The above configuration of the loader arm 270 can also be applied to the solid target irradiator system 10. In all other respects, the loader arm 270 functions the same as the loader arm 70.

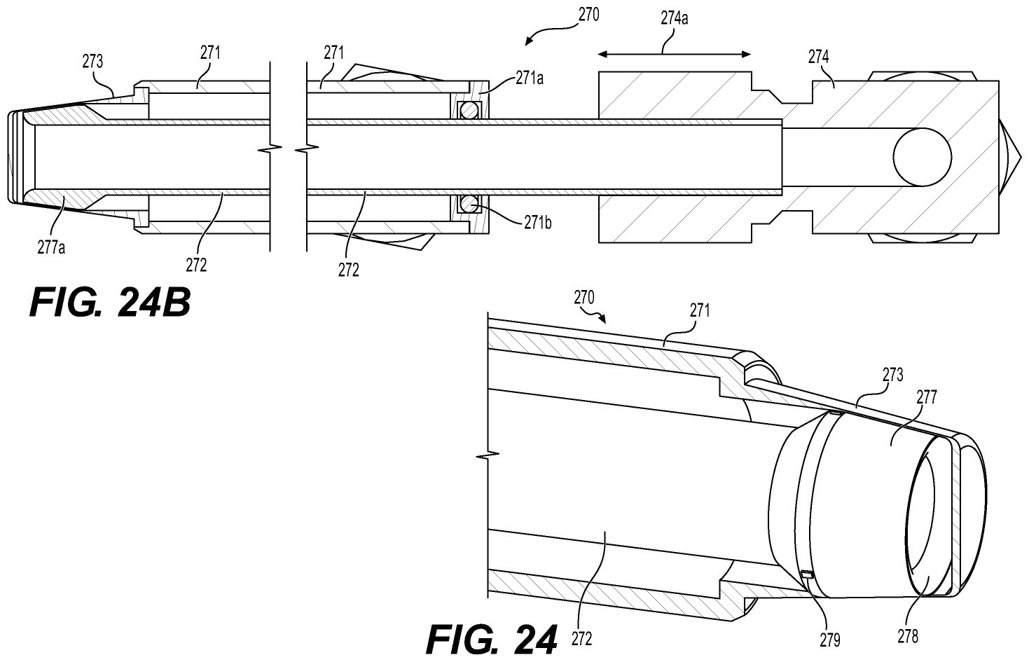

Referring to FIGS. 24A and 24B, these figures depict an alternative nozzle head 277a to facilitate a mechanically actuated expansion of the thin wall. Similar to the nozzle head 277, the nozzle head 277a is generally frustoconical in shape and configured with larger outer dimensions that conform with the inner dimensions at the tip section of the target plug 273. The inner diameter of the nozzle head 277a is the same as the inner diameter of the inner tube 272. The nozzle head 277a includes a fluted spout 278a at the open end of the nozzle head 277a to efficiently disperse exiting coolant through the space between the outer tube 271 and the inner tube 272.

Unlike the nozzle head 277, the nozzle head 277a also includes a plurality of generally elongate, flat channel facets 277b angularly spaced around the tapered surface of the nozzle head 277a. The channel facets 277b are generally oval in shape with vertices intersecting the top and base, respectively, of the generally frustoconical shape. Adjacent channel facets 277b form generally hourglass-shaped contact ridges 279a to rest against the inner wall of the target plug 273. This construction forms a generally multi-sided polygon confined within the inner diameter of the target plug 273 when viewed in cross section perpendicular to the axis of the inner tube 272. When the nozzle head 277a is seated inside the target plug 273 in a similar manner to that shown in FIG. 24, the vertices of the channel facets 277b form gaps between adjacent contact ridges 279a enabling coolant flow through the channel facets 277b at a desired velocity.

In use and after the target carrier 250 has been seated on the target plug 273 and coolant is flowing, the inner tube 272 is advanced towards the tip of the target plug 273 a relatively short distance, about 1-2 mm, by an actuator (not shown) coupled to the back of the inner tube 272 or the coolant inflow coupling 274, this movement indicated by arrows 274a. The back of the outer tube 271 is sealed with respect to the inner tube 272 by an annular endcap 271a and sealing ring 271b, and the rear portion of the inner tube 272, along with the coolant inflow coupling 274, extends away from the back of the outer tube 271 to form a gap to facilitate relative movement of the inner tube 272. Subsequent advancement of the nozzle head 277a wedges the same against the thin wall portion of the target plug 273 causing the thin wall to expand due to this mechanical wedging action and increase the grip on the socket 255 of the held target carrier 250. It is to be understood that the channels 277b and the ridges 279a can be provided in any shape or size so long as they can facilitate selective expansion of the thin wall and enable desired coolant flow and velocity.

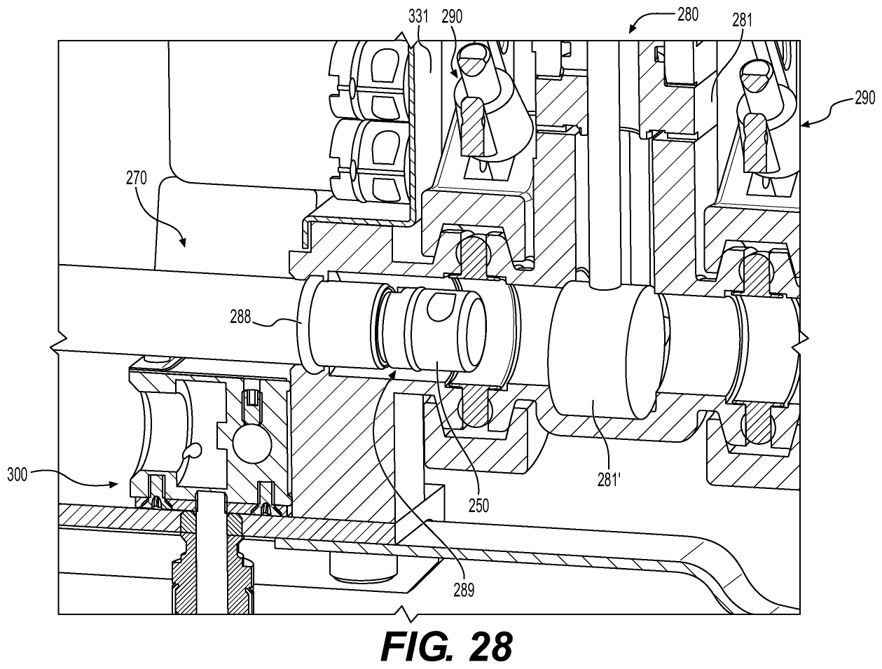

As best seen in FIGS. 18, 19, and 28, the airlock assembly 280 includes a selectively actuatable gate valve 281 mounted to the front end of the base 211, a target entrance port 282 extending upward from the rear of the gate valve 281, a target exit port 283 extending downward from the front of the gate valve 281, and an atmosphere control port 284 extending from a side of the gate valve 281. It can be seen from FIG. 28 an airlock seal 288 seals an interior airlock chamber 289 from the outside environment when the loader arm 270 and the held target carrier 250 are in an atmosphere conditioning state. In this state, a reciprocating gate 281′ is in a closed condition which prevents further advancement of the loader 270 until vacuum has been established by evacuating air through the atmosphere control port 284. A seal clamp 290 at opposite ends of the gate valve 281 are used to couple the respective ends to the target entrance port 282 and the target exit port 283. The airlock assembly 280 functions the same as the airlock assembly 80 in all other respects.

As best seen in FIGS. 18, 19, 29, and 30, the dissolution assembly 300 includes a dissolution housing 301, generally a rectangular block in shape, coupled to a pneumatic cylinder 304. It is noted that FIG. 29 is not a perspective view of the dissolution assembly 300 in a working orientation. This perspective has been used to better show details of the dissolution assembly 300. The pneumatic cylinder 304 includes a reciprocating piston rod 304′ directly connected to the dissolution housing 301 such that selective actuation of the pneumatic cylinder 304 raises or lowers the piston rod 304′ to facilitate corresponding selective raising and lowering of the dissolution housing 301. The dissolution assembly 300 is mounted to the base 211 between the target carrier feeding assembly 220 and the airlock assembly 280, and the dissolution assembly 300 is selectively raised to be in the path of travel of the connected target carrier 250 and selectively lowered to clear this path of travel.

The dissolution housing 301 includes an interior chamber or cavity 302 for holding dissolution chemicals. A target receiving port 303 in communication with the cavity 302 is formed on a front side of the dissolution housing 301 (as viewed in FIG. 29) for inserted reception of an irradiated target carrier 250. In use, the cavity 302 is sealed by the target seal 257 on the irradiated target carrier 250.

To facilitate the dissolution process, the dissolution assembly 300 includes a dissolution chemicals supply fitting 305 disposed on a side of the dissolution housing 301. This dissolution chemicals supply fitting 305 enables injection of chemicals or solution, such as HCL, required for the dissolution process. A lower liquid level sensor 306 is disposed on a lower operating point on a side of the dissolution housing 301 and an upper liquid level sensor 307 is disposed at a higher operating point on the same side as the lower liquid level sensor 306 on the dissolution housing 301. These sensors 306, 307 monitor the level of solution contained in the cavity 302 so as to ensure a suitable, predetermined volume of solution is maintained in the cavity 302 during the dissolution process. A heater 308 is coupled to the opposite side of the dissolution housing 301 to selectively heat the cavity 302 and the solution contained therein. The heater 308 promotes and optimizes chemical activity due to the addition of thermal energy. In an embodiment, the heater 308 may include a low voltage, 6 mm, 25 W cartridge heater (glass fiber insulation wire) inside cavity 302 and a 1/16″ diameter Kapton-coated K-type thermocouple (glass fiber insulation wire) similar to Omega CASSIM15G-300-PFA in contact with the solution. Operating temperature can range up to 120° C.

A gas tube fitting 309 is desirably disposed on the dissolution housing 301 to selectively introduce compressed gas and promote movement of the dissolution chemicals within the cavity 302 during a dissolution cycle. The ingress of compressed gas also assists in flushing the dissolution chemicals back through the dissolution chemicals supply fitting 305 after the dissolution cycle for subsequent collection of the radioisotopes produced by the dissolution process. In an example and as with the previously described dissolution assembly 100, the gas tube fitting 309 and the dissolution chemicals supply fitting 305 can be coupled to the dissolution system 1000 to obtain and collect radionuclides.

It can be seen from the above that the assemblies of the solid target irradiator system 210, such as the target carrier feeding assembly 220, target loader assembly 260, airlock assembly 280, and the dissolution assembly 300 all function similarly to their counterparts in the solid target irradiator system 10 albeit in a vertical orientation. Additionally, the solid target irradiator system 210 follows the same operational steps 1100 with minor variations. However, the vertical orientation poses an issue with disposal of spent target carriers 250′, since in the vertical orientation, a stripped spent target carrier 250′ would fall down towards the target entrance port 282.

Referring to FIGS. 18, 19, 26, 27, and 30, the solid target irradiator system 210 includes a spent target disposal assembly 330. The spent target disposal assembly 330 includes a target disposal trough 331 mounted to the airlock assembly 280 above the target entrance port 282. The target disposal trough 331 is dimensioned to have a capacity for holding a plurality of spent target carriers 250′ therein. The target disposal trough 331 has an open side that communicates with the dissolution housing 301. A deflector shield 332 is mounted to the dissolution housing 301. In the view shown in FIG. 18, the mounting would be on the front side of the dissolution housing 301. The deflector shield 332 comprises a pair of outwardly angled deflector plates 333 that span outward and past vertical walls of the target disposal trough 331 and cover the opening. A deflector spring is mounted between the deflector plates 333.

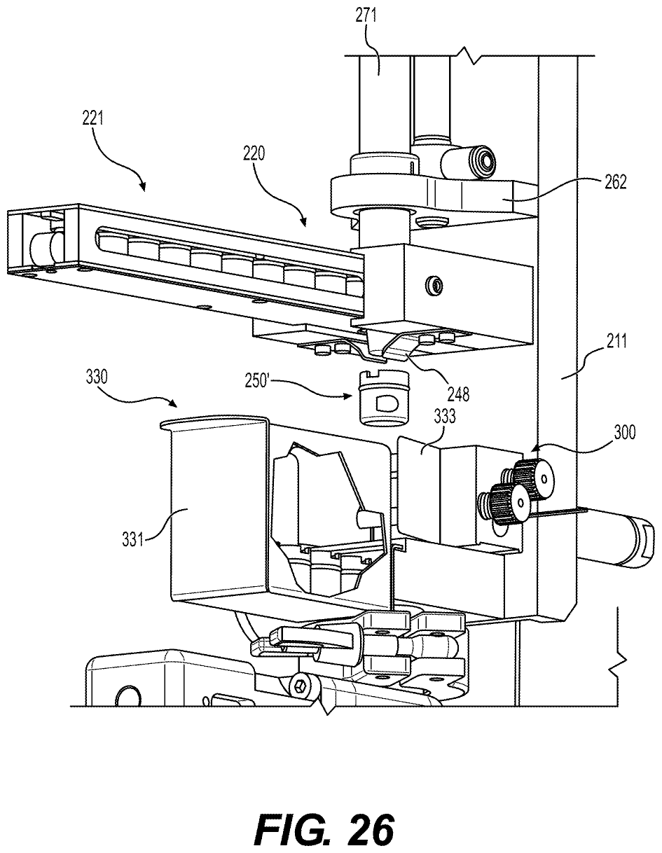

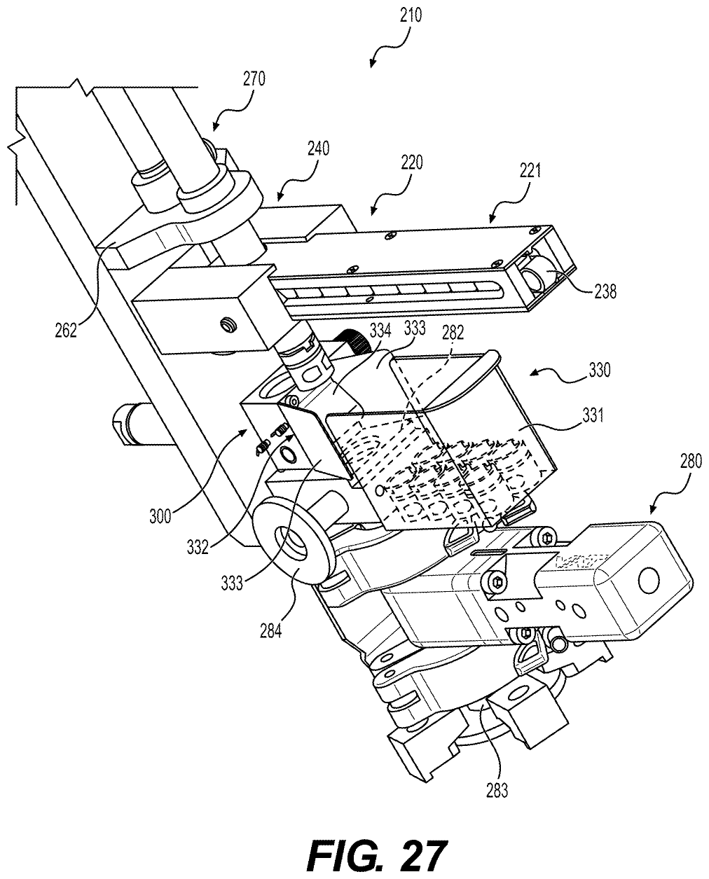

In use, a spent target carrier 250′ stripped from the target plug 273 by the target stripper 248 is allowed to fall by gravity. As best seen in FIGS. 26 and 27, the falling spent target carrier 250′ will be deflected towards the target disposal trough 331 by bouncing off the deflector spring 334 in the path of the fall. The trajectory of the fall and deflection may not be ideal in all instances. However, the fall and deflection of the spent target carrier 250′ is confined by the deflector plates 333 of the deflector shield 332 which are angled to deflect objects towards the target disposal trough 331. Besides directing the fall of the spent target carriers 250′, the deflector shield also shields those around the solid target irradiator system 210.

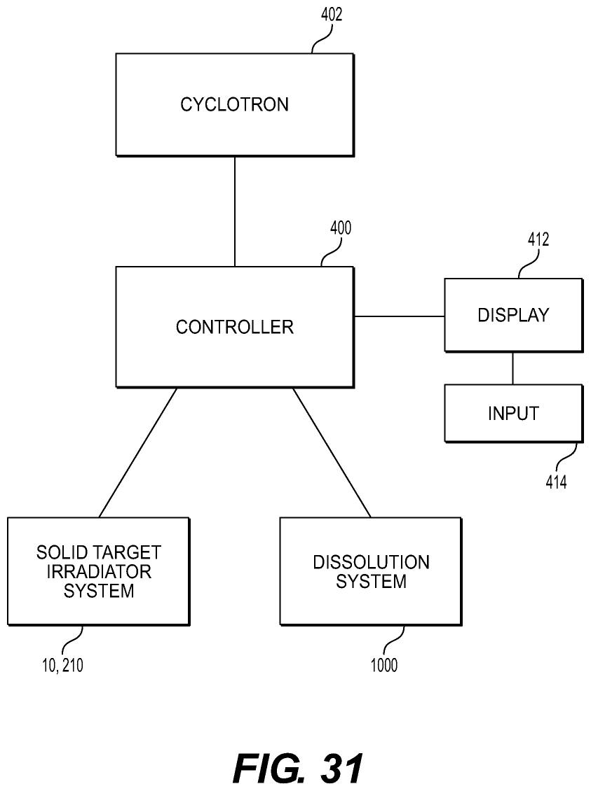

The solid target irradiator system 10, 210 is desirably an automated system where all the operational steps are controlled by a controller 400. Referring to FIG. 31, the controller 400 controls operations of the solid target irradiator system 10, 210, and it is in operative communication with the solid target irradiator system 10, 210, the dissolution system 1000, and the cyclotron 402. The controller 400 may represent, for example, a stand-alone computer, computer terminal, portable computing device, networked computer or computer terminal, or networked portable device. Data may be entered into the main controller 400 by the user via any suitable type of user interface, such as a display 412 and input 414, and may be stored in a computer readable memory, which may be any suitable type of computer readable and programmable memory. Calculations are performed by a controller/processor, which may be any suitable type of computer processor, and may be displayed to the user on a display 412, which may be any suitable type of computer display, such as a liquid crystal display (LCD) or a light emitting diode (LED) display, for example.

The controller/processor may be associated with, or incorporated into, any suitable type of computing device, for example, a personal computer or a programmable logic controller (PLC) or an application specific integrated circuit (ASIC). The display 412, the controller/processor, the memory, and any associated computer readable media are in communication with one another by any suitable type of data bus, as is well known in the art. In this manner, the main controller 400 is in communication with the systems noted above.

Examples of computer readable media include a magnetic recording apparatus, non-transitory computer readable storage memory, an optical disk, a magneto-optical disk, and/or a semiconductor memory (for example, RAM, ROM, etc.). Examples of magnetic recording apparatus that may be used in addition to memory, or in place of memory, include a solid state disk (SSD), hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that elements of the solid target irradiator system 10, 210, whole or in part, can be constructed from a variety of components and materials. For example, pneumatic actuators may be readily available off-the-shelf components constructed from stainless steel, aluminum, and/or other metals. The dissolution housing is desirably constructed from high chemical resistant materials such as PEEK, VESPEL, ceramic, or machinable ceramic. The O-rings and tubes are desirably constructed from flexible material such as polyurethane ether. The springs may be constructed from carbon steel, and majority of the loader arm may be made with stainless steel such as 316 steel. The target plug may be constructed from various materials such as steel, bronze, beryllium copper alloy, or nickel. These are all examples and should not be construed in any limiting sense.

It is to be understood that the present invention is not limited to the embodiments described above, but encompasses any and all embodiments within the scope of the following claims.

1. A solid target irradiator system for producing radioisotopes, comprising:
a base;
a target carrier feeding assembly coupled to the base, the target carrier feeding assembly having a target magazine configured to hold at least one target carrier therein and feed the at least one target carrier for dissolution processing, each at least one target carrier having target material thereon for subsequent irradiation;
a target loader assembly coupled to the base and spaced from the target carrier feeding assembly, the target loader assembly having a reciprocating loader arm for selectively engaging and holding the at least one target carrier being fed by the target magazine, the loader arm configured to move a held target carrier through the irradiator system to facilitate irradiation of the target material and dissolution of an irradiated target material, the loader arm having a cooling means for internal cooling of the target material being irradiated;
an airlock assembly coupled to the base and spaced from the target carrier feeding assembly, the airlock assembly having a gate valve, an airlock chamber within the gate valve for receiving the held target carrier therein, and a target exit port adapted to be coupled to a cyclotron chamber in vacuum, the airlock assembly configured to selectively establish a vacuum seal prior to introducing the held target carrier to the cyclotron chamber for irradiation; and
a dissolution assembly coupled to the base between the target carrier feeding assembly and the airlock assembly, the dissolution assembly having a selectively moveable dissolution housing for engaging an irradiated target carrier with irradiated target material thereon, the dissolution housing having a cavity in selective communication with the irradiated target carrier, the cavity configured to be filled with dissolution solvent to dissolute the irradiated target material and collect radionuclides for subsequent separation and production of radioisotopes.

2. (canceled)

3. The solid target irradiator system for producing radioisotopes of claim 1, wherein the target magazine comprises:
an elongate substantially rectangular tube member having a target holder cradle therein for holding a plurality of target carriers in a stacked configuration, the target holder cradle including a pair of spaced elongate leg sections with each leg section having an elongate slot formed thereon to provide visual and physical access to one or more target carriers contained in the target magazine and reduce weight; and
a pass-through hole formed on a bottom portion of the rectangular tube member, the pass-through hole being coaxially aligned with the loader arm during use, the pass-through hole being positioned to expose a select target carrier contained in the target magazine for selective access by the loader arm to hold and move the select target carrier out of the target magazine.

4. The solid target irradiator system for producing radioisotopes of claim 3, further comprising a biasing means coupled to the target magazine, the biasing means biasing the stack of target carriers towards the pass-through hole.

5. The solid target irradiator system for producing radioisotopes of claim 3, wherein the target carrier feeding assembly comprises:
a target magazine support subassembly coupled to the base, the target magazine support subassembly configured to selectively receive and secure the target magazine thereon; and
a target stripper coupled to the target magazine support subassembly at a relative position adjacent the pass-through hole of the target magazine when the target magazine is secured to the target magazine support subassembly, the target stripper configured to strip the held target carrier off the loader arm during retraction of the loader arm after irradiation of the held target carrier.

6. The solid target irradiator system for producing radioisotopes of claim 1, wherein the loader arm comprises a target plug at a distal end for selective connection with the least one target carrier, the target plug having a thin wall selectively expandable by coolant from the cooling means.

7. The solid target irradiator system for producing radioisotopes of claim 6, wherein the loader arm further comprises:
an elongate outer tube having the target plug at a distal end of the outer tube; and
an elongate inner tube concentrically disposed within the outer tube, the inner tube having an open distal end adjacent the target plug, the inner tube and the outer tube dimensioned to provide space between an inner wall of the outer tube and an outer wall of the inner tube.

8. The solid target irradiator system for producing radioisotopes of claim 7, wherein the cooling means comprises:
a coolant supply line coupled to a rear end of the inner tube, the coolant supply line configured to selectively supply coolant through the inner tube; and
a coolant outflow line coupled to a rear end of the outer tube, the coolant outflow line configured to selectively drain the coolant from the loader arm,
wherein the coolant supplied through the open end of the inner tube impinges on the thin wall of the target plug from inside the target plug to selectively expand the thin wall, the selective expansion of the thin wall securely holds the held target carrier and the coolant cools the held target carrier during irradiation of the target material, the space between the outer tube and the inner tube facilitating circulation of the coolant and drains the coolant through the coolant outflow line.

9. The solid target irradiator system for producing radioisotopes of claim 1, wherein the target loader assembly comprises:
a first guide support bracket;
a second guide support bracket spaced from the first guide support bracket;
at least one guide rod extending between the first and second guide support brackets;
at least one drive shaft extending between the first and second guide support brackets;
a driver coupled to the drive shaft to selectively activate the at least one drive shaft;
a manipulator carriage coupled to the at least one guide rod and the at least one drive shaft, the manipulator carriage configured to selectively move in a reciprocating manner between the first and second guide support brackets from selective activation of the driver, the loader arm being coupled to and carried by the manipulator carriage, the loader arm extending from the manipulator carriage towards the airlock assembly; and
a plurality of carriage stops disposed on the base at predetermined intervals, each carriage stop being selectively actuatable to provide a stop abutment for the manipulator carriage and maintain positioning of the manipulator carriage at various stages of the radioisotope production process.

10. The solid target irradiator system for producing radioisotopes of claim 9, wherein each carriage stop comprises a piston cylinder having a selectively extendable piston rod.

11. The solid target irradiator system for producing radioisotopes of claim 1, wherein the airlock assembly comprises an atmosphere control port in communication with the airlock chamber and adapted to be coupled to an air pump, the atmosphere control port facilitating selective vacuum within the airlock chamber prior to introducing the held target carrier to the cyclotron chamber for irradiation and establishing ambient atmosphere within the airlock chamber after irradiation and retraction of the held target carrier back into the airlock chamber.

12. The solid target irradiator system for producing radioisotopes of claim 1, wherein the dissolution assembly comprises:
a dissolution chemicals supply fitting disposed on the dissolution housing for selective introduction of dissolution solvent and other liquids;
a lower liquid level sensor coupled to the dissolution housing;
an upper liquid level sensor coupled to the dissolution housing, the lower liquid level sensor and the upper liquid level sensor monitoring the level of liquid within the cavity and maintain a predetermined volume of solution therein;
a heater coupled to the housing to selectively heat content within the cavity and promote chemical activity through addition of thermal energy; and
a gas tube fitting coupled to the housing to selectively introduce gas and promote movement of the content.

13. The solid target irradiator system for producing radioisotopes of claim 1, wherein the target carrier comprises:
a substantially rectangular block body having a curved front face, the target material being disposed on the curved front face; and
a socket formed on a rear end of the substantially rectangular block body, the socket adapted to selectively engage and receive a distal end of the loader arm.

14. The solid target irradiator system for producing radioisotopes of claim 1, wherein the target carrier comprises:
a substantially cylindrical body having a flat front face, the target material being disposed on a curved side of the substantially cylindrical body; and
a socket formed on a rear end of the substantially cylindrical body, the socket adapted to selectively engage and receive a distal end of the loader arm.

15. The solid target irradiator system for producing radioisotopes of claim 1, wherein the target carrier comprises a target body, and a material of the target body is selected from the group consisting of copper, silver, and thermoconductive material.

16. The solid target irradiator system for producing radioisotopes of claim 1, wherein the target material is selected from the group consisting of zinc, nickel, and suitable material for radioisotope production.
